(19) United States
(12) Patent Application Publication
(10) Pub. No.: US 2026/0258324 A1
(43) Pub. Date: Sep. 3, 2026

(54) Granules comprising bleaching catalyst or precursor thereof, bleaching agent and cleaning agent comprising same and use thereof

(71) Applicant: Catexel GmbH, Wiesbaden (DE)

(72) Inventors: Paul Kaufmann, Hochheim (DE); Rolf Ludwig, Ehlhalten (DE); Judith Preuschen, Sörgenloch (DE); Ronald Hage, Leiden (NL); Yfranka Roelofsen, Leiden (NL); Yifei Zhan, Wiesbaden (DE); Stefan Riegelbeck, Kelkheim (DE); Khalid Douiri, Wiesbaden (DE)

(21) Appl. No.: 19/547,369

(22) Filed: Feb. 23, 2026

(30) Foreign Application Priority Data
Feb. 26, 2025 (EP) 25000022.1
Jun. 30, 2025 (EP) 25000073.4

(51) Int. Cl. C11D 3/395; C11D 3/16; C11D 3/22; C11D 3/32; C11D 3/37

(52) U.S. Cl. CPC C11D 3/3951; C11D 3/168; C11D 3/222; C11D 3/225; C11D 3/323; C11D 3/3753; C11D 3/3761; C11D 3/3953

(57) ABSTRACT

Granules comprising bleaching catalyst or precursor thereof, bleaching agent and cleaning agent comprising same and use thereof

Disclosed are uncoated granules comprising increased amounts of protonated or non-protonated triazacyclic compounds or comprising manganese complex salts having at least one triazacyclic ligand combined with selected anions and a selected anti-agglomeration agent, which granules contain between 0 to 1.5 wt.-% of a selected water-soluble, film-forming polymer.

The protonated or non-protonated triazacyclic compounds or the manganese complex salts can be used as a binder in the granules and conventional binder polymers can be omitted.

The invention also relates to a bleaching formulation and a laundry detergent or dishwashing formulation comprising these granules.

The granules are storage stable and remain fully active in a laundry washing agent or a dishwashing agent.

### CLAIM FOR PRIORITY

This application is a US national phase application of European Patent Application No 25000022.1, filed Feb. 26, 2025, and of European Patent Application No 25000073.4, filed Jun. 30, 2025 the priority of which are hereby claimed and their disclosures incorporated herein by reference.

### FIELD OF THE INVENTION

The present invention pertains to granules comprising a selected bleaching catalyst of precursor thereof.

The invention also pertains to bleaching formulations comprising said granules and a peroxy compound or a precursor thereof. The granules and formulations comprising said granules can be used in catalysing oxidation or bleaching, for example as a component of a detergent or an automatic dishwashing agent.

### BACKGROUND

Manganese bleach catalysts based on triazacyclononane ligands are known to be active catalysts in the bleaching of stains in laundry detergent products and in dishwash products and for treatment of cellulosic substrates in e.g. wood-pulp or raw cotton (see for example EP 0 458 397 A2 and WO 2006/125517 A1).

Since these catalysts are very effective, only small amounts of them need to be used in bleaching detergent or dishwash formulations, often at levels less than 0.1 wt % in the detergent or dishwasher formulation. A difficulty arising from the use of such low dosing is achieving accurate dosing of the catalyst and homogeneous distribution throughout the formulation. When distribution of the catalyst is heterogeneous in a formulation, the use of such detergent formulations in a washing machine or in handwashing can lead to underdosing (i.e. giving a poorer bleaching performance) or overdosing of the catalyst (i.e. giving rise to excessive hydrogen peroxide decomposition and possibly brown spotting). A well-known approach to circumvent this potential problem is the inclusion of the solid catalyst in a granule.

In general, a disadvantage of the approach of using granules comprising manganese bleach catalysts is that these will be intensely coloured. Inclusion of palely coloured or even white granules would be appealing.

### PRIOR ART

Manganese catalysts based on triazacyclononane ligands are known to be active catalysts in the bleaching of stains in laundry detergent products and in dishwash products and for treatment of cellulosic substrates in e.g. wood-pulp or raw cotton (see for example EP 0 458 397 A2 and WO 2006/125517 A1.

EP0549271 B1 discloses the use of 1,4,7-trimethyl-1,4,7-triazacyclononane (hereinafter Me₃TACN), optionally as a protonated salt, in conjunction with a Mn source, such as Mn(nitrate)₂ or a Mn-Me₃TACN containing complex to enhance bleaching activity of hydrogen peroxide.

It is known that using the Me₃TACN ligand salt without any source of Mn in the detergent bleaching formulation an enhancement of the bleaching activity by hydrogen peroxide can be found. The presence of manganese ions in certain stains leads to binding of the ligand to the Mn ions and then bleach-active species are formed. EP0902021 A2 describes the use of cyclic polyamine salts, such as the monoprotonated Me₃TACN ligand salts in detergent formulations to enhance bleaching performance by hydrogen peroxide. Moreover, the use of non-protonated Me₃TACN ligand in detergent formulations for the same application has been disclosed in WO 2018/141237 A1. Thus, these protonated ligand salts act as precursors of manganese-containing bleaching catalysts.

Reinhardt et al. describe in Household and Personal Care Today, vol. 9, no. 4, pp. 54-57 (2014), ligand salts as metal-free bleach boosters for laundry applications to bleach stains with H₂O₂. The stain contains Mn, which then binds to the ligand and gives an active Mn-Me₃TACN bleaching catalyst/species. Disclosed are protonated Me₃TACN salts, in particular a series of monoprotonated Me₃TACN salts, such as with HSO₄⁻, PF₆⁻, BF₄⁻, ClO₄⁻, oxalate, acetate, citrate and polyacrylic acid. This document discloses as one embodiment ligand salts in granular form, preferred as co-granules with enzymes, bleach activators or sodium percarbonate. No details about the composition of these granules or co-granules are given nor are there any data about their properties, such as storage stability or bleaching activity.

EP 3874949 A1 discloses granules comprising Mn oxalate and ligand salts that contain a polysaccharide based absorbent and a coating agent, preferably polyvinyl alcohol. In this document also reference was made to such granules containing the ligand salt without inclusion of Mn oxalate.

EP 4296344 A1 discloses granules comprising Mn acetate, ligand salt, polyvinyl alcohol with optionally a coating based on polyvinyl alcohol (hereinafter PVOH). Typically the granules exemplified contain between 1 and less than 5 wt % of the ligand salt. In this document it was also shown that the inclusion of PVOH inside the granule is essential to get good storage stability.

From WO 2022/122177 A1 granules comprising protonated triazacyclic compounds are known. These are coated granules and comprise besides a protonated ligand salt a polysaccharide absorbent and Mn(II)oxalate or these are coated or uncoated granules, have no or traces of Mn and comprise besides a protonated ligand salt a polysaccharide absorbent. These granules are white and storage stable and show high bleaching performance. Typically the granules exemplified contain about 2.5 wt.-% of the ligand salt. When investigating these no Mn-containing granules it appeared that granules having increased amounts of 3 wt.-% or higher of protonated ligand salt became sticky and the granules tended to agglomerate. Thus, granules comprising higher amounts of ligand salt are of limited commercial value.

From US 2009/0289221 A1 certain aminoacetones and salts thereof are disclosed which can be used in a bleaching system comprising inorganic peroxygen compounds for increasing the bleaching effect of peroxygen compounds during the bleaching of coloured soiling on textiles and on hard surfaces. This document also discloses granules made from acid-modified bentonite and diethylaminoacetone hydrochloride. Experiments showed that combinations of acid-modified bentonite and protonated cyclic triamine salts could not be processed to form granules. Moreover, as is known from WO 2008/015443, aminoacetones can only activate inorganic peracids or salts thereof, such as potassium persulfate, but not hydrogen peroxide. Finally, in this document a pH-range of the aqueous bleaching solution between 7 and 9 is required while all bleach-containing laundry agents today have pH-values of 10 or higher and bleaching catalysts comprising cyclic triamine ligands need pH-values of 9.5 and above.

WO2018/011596A1 discloses catalyst compositions comprising bleach-activating catalyst, water-soluble polymer, absorbent and filler. Transition-metal based salts or complexes are mentioned as bleach-activating catalysts. The catalyst compositions comprise small amounts of water-soluble polymer, such as polyvinyl alcohol. Preferred bleach catalysts are [Mn^{IV}₂(μ-O)₃(Me₃TACN)₂](PF₆)₂ and [Mn^{III}Mn^{IV}(μ-O)₂(μ-CH₃COO)(Me₄DTNE)](PF₆)₂.

WO2016/005392A1 discloses granules comprising an enzyme-containing core said core being surrounded by a first coating comprising a manganese containing bleach catalyst having a di- or trimethylazacyclonane ligand said first coating being surrounded by a second coating comprising at least 60% b.wt. of a water-soluble salt having a constant humidity at 20° C. above 85%. No details of specific bleach catalysts are found neither in the general specification nor in the examples of this document. The specification states TACN but from the disclosure it is evident that a Mn-complex salt with TACN as a ligand was used.

The commercial product available at that time was complex salt [Mn^{IV}₂(μ-O)₃(Me₃TACN)₂](PF₆)₂ (hereinafter Mn-TACN PF₆) which has a water solubility of 10.8 g/L. This compound is therefore not suitable for wet granulation.

EP 3 190 168 A1 discloses coated co-granules comprising a core containing a metal-containing bleach catalyst and a binder, which is preferably a cellulosic polymer. The coating comprises selected film-forming polymers, e.g. polyvinyl alcohol, or an acidic compound, e.g. a copolymer comprising sulfonic acid groups, or carboxylic acids.

US 2012/0094889 A1 discloses co-granules comprising a bleach activator, a metal-containing bleach catalyst and at least 5% b.wt. of an organic acid. The bleach activators disclosed in this document are substances known in the art to activate bleach performance, for example polyacylated alkylenediamines, such as TAED. The bleach catalysts disclosed in this document are bleach boosting transition metal salts and/or complexes of Mn, Fe, Co, Ru, Mo, Ti or V. Examples of bleach catalyst are Mn-(II)-sulfate or Mn-(II)-acetate. Organic acids described in this document are monomeric or polymeric acids or partly neutralized forms thereof. Examples are citric acid or ascorbic acid.

US 2012/0058927 A1 discloses co-granules comprising a granule core and a coating layer surrounding the core. The granule core comprises a bleach activator and a binder. The coating layer comprises a bleach catalyst and a coating agent. Bleach catalysts are bleach boosting transition metal salts and/or complexes of Mn, Fe, Co, Ru, Mo, Ti or V. Bleach activators are substances known in the art to activate bleach performance. Examples for these are polyacylated alkylenediamines, such as TAED. Binders are substances selected from fatty acids, alcohol ethoxylates, polymers and natural clay minerals. Coating agents are materials used as binders except natural clay minerals.

WO 2022/058039 A1 discloses granules comprising a water-soluble polymer, a polysaccharide adsorbent and a water-soluble transition metal ion containing bleaching catalyst. These granules exhibit high bleaching activity and are stable for extended storage time. Typically the granules exemplified contain between 2 and 7 wt.-% of the bleaching catalyst combined with 1.6 to 4.4 wt.-% of polyvinyl alcohol. Experiments have shown that the presence of higher amounts of water-soluble film-forming polymers, such as polyvinyl alcohol have a negative impact on the storage stability of the granules and result in deterioration of the bleaching performance of laundry detergents or dishwashing formulations after storage.

Moreover, for wet granulation water-soluble film-forming polymers, such as polyvinyl alcohol, are added as aqueous solutions. When higher amounts of these polymers are included in the granules aqueous solutions having higher polymer concentrations are added to the granulation device. The viscosity of these solutions is often too high and results in problems in the mixing process.

There remains a need in the art of bleaching formulations, for example of use in dishwashing or laundry cleaning applications, to develop colourless granules containing a high amount of active ingredients that show good storage stability and high bleaching activity. The present invention is intended to address these needs.

### SUMMARY OF THE INVENTION

In an effort to improve granules comprising bleaching catalysts for use in laundry or dishwash cleaning detergent products it was investigated to enlarge the dose levels of the ligand salt active material in the granules over those that would typically be used in granules for laundry detergents or for dishwashing formulations.

It was found that the bleaching catalyst or precursor thereof as such is difficult to be formulated as the fine powder cannot be distributed evenly in the product and that the bleaching catalyst or precursor thereof in the formulation, without being present in a granule combined with selected ingredients, is of limited storage stability.

Furthermore, the amount of bleaching catalyst or precursor thereof in the granule should be higher than what has been developed for commercially available granules.

The inventors have surprisingly found that granules comprising increased amounts of selected bleaching catalysts or precursors thereof, such as protonated cyclic triamine salts or highly water-soluble manganese complex salts containing cyclic triamine ligands and selected anions, need an anti-agglomeration agent in order to prevent the granules to adhere to each other after preparation. Moreover it was found that the bleaching catalyst or precursor thereof, such as the ligand salt itself, acts as a binder so that addition of other binder polymers can be avoided or kept at a low level. These granules show very high bleaching activity for useful periods of storage time.

In addition, the inventors have surprisingly found that granules comprising no or only small amounts of selected water-soluble, film-forming polymers, such as polyvinyl alcohol (PVOH), are more storage stable and show better bleaching results after storage compared to granules comprising higher amounts of these polymers.

We have surprisingly found that using a high loading of manganese complex salt dissolved in water, e.g. 15 wt.-% [Mn^{IV}₂(μ-O)₃(Me₃TACN)₂](SO₄) (hereinafter Mn-TACNSO₄) solution in water, still made it possible to get good granules without Braunstein formation which also showed good stability in ADW tablets. Moreover, the selected manganese complex salts or ligand salts form nicely stabilized crystalline solids which allow easy processing into granules.

In an embodiment or first aspect, the invention provides granules having selected bleaching catalysts or precursors thereof combined with selected anti-agglomeration agents and containing no or only small amounts of selected water-soluble, film-forming polymers, which granules are storage stable and can be used in laundry detergent compositions as well as in dishwashing formulations, yet providing high bleaching activity. Preferably these granules contain high amounts of these bleaching catalysts.

In an alternate embodiment or, second aspect, the invention provides a bleaching formulation comprising the granules according to the first aspect of the invention.

In yet another embodiment or third aspect, the invention provides a method comprising contacting a substrate with water and a bleaching formulation according to the second aspect of the invention.

In yet another embodiment or fourth aspect, the invention provides a method comprising the preparation of the granules according to the first aspect of the invention.

Further aspects and embodiments of the present invention will be evident from the discussion that follows below.

The inventors have developed granules based on selected manganese-containing bleaching catalysts or precursors thereof, such as protonated cyclic triamine ligand salts, e.g. protonated Me₃TACN ligand salt, and a selected anti-agglomeration agent having no or low amounts of water-soluble, film-forming polymers, that provide an excellent bleaching performance and show a high storage stability in a laundry detergent or dishwashing formulation.

In the investigation tests were carried out with the objective to raise the dose levels of the bleaching catalyst or precursor thereof to be higher than what would be typically used in commercially available granules.

The inventors conducted studies to increase the amount of bleaching catalyst or precursor thereof in the granule. Following a recipe similar to what is disclosed in EP 4296344 A1 a granule with about 5 wt-% protonated ligand salt could be obtained. Removing PVOH from the recipe and adding polysaccharide absorbent resulted in a possibility to make granules containing much higher levels of protonated ligand salt

It was found that this could be performed by either adding the protonated ligand salt or the manganese complex salt as a solid into the mixture or by first dissolving it in water and then carry out the granulation. Then, most surprisingly, stable granules could be obtained when using only protonated ligand salt or manganese complex salt dissolved in water. Optionally a polysaccharide absorbent, such as a starch, or low amounts of PVOH may be included.

### DETAILED DESCRIPTION

As summarised above, the present invention relates to an uncoated granule comprising
a) 1-95 wt-% of a manganese bleaching catalyst of formula (A1) defined below, a chelating ligand L or L-BG-L, or a mono- to hexa-protonated salt of a chelating ligand L or L-BG-L, wherein L is a monocyclic triamine, and BG is a divalent organic bridge group, and an anti-agglomeration agent selected from the group consisting of at least one of components b), c) and/or d), wherein
b) is a bleach activator,
c) is a cellulose ether, and
d) is a polysaccharide absorbent selected from the group consisting of starch, modified starch, glycogen or natural gum,
which granule has 0 to 1.5 wt.-% of a water-soluble, film-forming polymer selected from the group consisting of polyvinylpyrrolidones, polyalkylene glycols, polyvinyl alcohols, polyacrylic acid homo- or copolymers, polymethacrylic acid homo- or copolymers or salts of these homo- or copolymers.

The granules of the invention contain as an anti-agglomeration agent at least one of components b), c) or d) or a combination of two or more thereof.

The granules of the invention contain 0 to 1.5 wt.-% of selected water-soluble, film-forming polymers defined above, preferably between 0 and 1.4 wt.-% of these water-soluble, film-forming polymers more preferred between 0 and 1.2 wt.-% of these water-soluble, film-forming polymer polymers and most preferred no water-soluble, film-forming polymer.

The term “water-soluble” of a compound when used in this description means a solubility of more than 30 g/L of said compound in water of 25° C.

In one embodiment the granules of the invention comprise a bleach activator (component b) as an anti-agglomeration agent.

Bleach activators are compounds generally known from the prior art. These are preferably multiple acylated alkylene diamines, in particular tetraacetylethylene diamine (TAED), acylated triazine derivatives, in particular 1.5-diacetyl-2, 4-dioxohexahydro-1,3,5-triazine (DADHT), acylated glycolurils, in particular tetraacetylglycoluril (TAGU), glyceroltriacetate (triacetin), N-acylimides, in particular N-nonanoyl succinimide (NOSI), acylated phenolic sulfonates, in particular n-nonanoyloxi- or n-lauroyloxibenzenesulfonate (NOBS or LOBS), acylated phenolic carboxylic acids, in particular nonanoyloxi- or decanoyloxibenzoic acid (NOBA or DOBA, respectively), carboxylic acid anhydrides, in particular phthalic acid anhydride, acylated multivalent alcohols, preferably triacetine, ethyleneglycol diacetate and 2.5-diacetoxy-2,5-dihydrofurane as well as acetyliertated sorbitol and mannitol or their mixtures, respectively (SORMAN), acylated sugar derivatives, preferably pentaacetylglucose (PAG), pentaacetylfructose, tetraacetylxylose and octaacetyllactose as well as acetylated and optionally N-alkylated glucamine and gluconolactone, and/or N-acylated lactams, for example N-benzoylcaprolactam. Hydrophilic substituted acylacetales and acyllactames can also preferably be used. In addition, nitrile derivatives such as n-methyl-morpholinium acetonitrile-methyl sulfate (MMA) or cyanomorpholine (MOR) can be used as bleach activators. Combinations of bleach activators can also be used.

Preferred anti-agglomeration agents b) are TAED, NOBS, triacetin, and DOBA. Very preferred is TAED.

In an embodiment, the granules of the invention comprise between 0 and 95 wt.-% of component b), preferably between 5 and 95 wt.-% of component b), more preferred between 50 and 95 wt.-% of component b), still more preferred between 70 and 90 wt.-%, and most preferred between 80 and 90 wt.-%.

In another embodiment the granules of the invention comprise a cellulose ether (component c) as an anti-agglomeration agent.

Cellulose ethers of component c) are derivatives of cellulose which are formed by partial or complete substitution of the hydrogen atoms of the hydroxyl groups in the cellulose. The type of substituents, the number of substituted hydroxyl groups and their distribution in the cellulose ethers used as anti-agglomeration agent can be varied over a wide range.

Preferred components c) are cellulose ethers containing no carboxyl groups. Examples of cellulose ethers containing no carboxyl groups that can be used as component c) are methyl cellulose (MC), ethyl cellulose (EC), hydroxymethyl cellulose (HMC), hydroxyethyl cellulose (HEC), hydroxypropyl cellulose (HPC), or cellulose mixed ethers, such as methyl ethyl cellulose (MEC), hydroxyethyl methyl cellulose (HEMC), hydroxypropyl methyl cellulose (HPMC) or ethyl hydroxyethyl cellulose. HEMC is also called methyl hydroxyethyl cellulose.

Additional examples of cellulose ethers that can be used as component c) are carboxymethyl cellulose (CMC) or carboxymethyl hydroxyethyl cellulose

Preferred components c) are MC, EC, HMC, HEC, MEC and very preferred HEMC and CMC.

In an embodiment, the granules of the invention comprise between 0 and 50 wt.-% of component c), preferred between 1 and 50 wt.-%, more preferred between 2 and 30 wt.-%, still more preferred between 3 and 20 wt.-%, and most preferred between 5 and 10 wt.-%

In another embodiment the granules of the invention comprise a selected polysaccharide absorbent (component d) as an anti-agglomeration agent.

Component d) is a polysaccharide absorbent. This acts as an anti-agglomeration agent and as a processing additive and helps to obtain suitable processing features, including absorbance and/or removal of water that may be present during the processing step to make the granules or the water that is present in the detergent formulation during the period of storing the detergent formulation. Component d) is selected from the group consisting of starch, modified starch, glycogen, natural gum, such as alginate or a combination thereof.

Natural gums are polysaccharides of natural origin which are capable of causing a large increase in solution viscosity. They are mostly botanical gums, found in the woody elements of plants or in seed coatings. Examples of natural gums are natural gums obtained from seaweeds, e.g. agar, alginic acid, sodium alginate and Carrageenan, or natural gums obtained from non-marine botanical resources, e.g. gum arabic, gum ghatti, gum tragacanth, Karaya gum, guar gum, Locust bean gum, beta-glucan, dammar gum, glucomannan, Psyllium seed husks and Tara gum, or natural gums produced by bacterial fermentation, e.g. gellan gum or xanthan gum.

Preferred component d) is a starch, which is a polymer of glucose in which the glucopyranose units are bonded by α-linkages. Suitable sources of starch are potato starch, maize starch, rice starch, wheat starch and partially pregellatinised starches from the aforementioned list. Alternatively, the polysaccharide absorbent may be a modified starch, such as dextrin, a gum or alginate.

Very preferred components d) are selected from the group consisting of corn starch, potato starch or rice starch.

In an embodiment, the granules of the invention comprise between 0 and 50 wt.-% of component d), preferred between 1 and 50 wt.-%, more preferred between 2 and 30 wt.-%, and most preferred between 5 and 20 wt.-%

In another embodiment the granules of the invention comprise in addition to component a), anti-agglomeration agent b), c) and/or d) and other optional ingredients an inorganic filler (component e).

Component e) is preferably selected from the group consisting of silicates, aluminium silicates or inorganic oxides, for example quartz. Preferred components e) are selected from the group consisting of talc, mica, silicate, silica, zeolite, clay or a combination thereof. Mixtures of two or more of these can also be used.

Component e) is preferably employed as powder.

Preferred components e) are silicates or zeolites.

In an embodiment, the granules of the invention comprise between 0 and 95 wt.-% of component e), preferred between 0 and 90 wt.-%, more preferred between 0 and 80 wt.-%, still more preferred between 0 and 50 wt.-%, and most preferred between 0 and 30 wt.-%.

In a preferred embodiment component e) is absent.

In another embodiment the granules of the invention comprise in addition to component a), anti-agglomeration agent b), c) and/or d) and other optional ingredients a siccative (component f).

Components f) are selected from the group consisting of alkali metal sulfate, alkali metal carbonate, alkaline earth metal sulfate, alkaline earth metal carbonate, alkaline earth metal oxide, aluminum oxide and/or hydrates of these compounds. Mixtures of two or more of these can also be used.

Preferably, components f) are used as hydrates, in particular as dihydrates.

Preferably used components f) are selected from the group consisting of sodium sulfate, magnesium sulfate, calcium sulfate, hydrates of these compounds or mixtures of two or three of them.

Sodium sulfate and calcium sulfate are particularly preferred as components f).

In an embodiment, the granules of the invention comprise between 0 and 95 wt.-% of component f), preferred between 0 and 90 wt.-%, more preferred between 0 and 80 wt.-%, still more preferred between 0 and 50 wt.-%, and most preferred between 0 and 30 wt.-%.

In a preferred embodiment component f) is absent.

In another embodiment the granules of the invention comprise in addition to component a), anti-agglomeration agent b), c) and/or d) and other optional ingredients an enzyme (component g).

Component g) can be an enzyme or a mixture of enzymes. Those knowledgeable of detergents, dishwashing formulations and bleaching formulations will be familiar with the use of enzymes in this context. Enzymes can provide cleaning performance, fabric care and/or sanitation benefits. Suitable enzymes include proteases, amylases, pullulanases, cutinases and/or lipases. Members of these enzyme classes are described in Enzyme Nomenclature 1992: Recommendations of the Nomenclature Committee of the International Union of Biochemistry and Molecular Biology on the Nomenclature and Classification of Enzymes, 1992, ISBN 0-1202271165-3, Academic Press. Detersive enzymes are described in greater detail in for example U.S. Pat. No. 6,579,839 (Price et al.).

In an embodiment, the granules of the invention comprise between 0 and 20 wt.-% of component g), preferred between 0 and 20 wt.-%, more preferred between 0 and 15 wt.-%, and most preferred between 0 and 10 wt.-%.

In a preferred embodiment component g) is absent.

The percentages by weight given in this specification refer to the total amount of a granule.

Very preferred are granules comprising as anti-agglomeration agent a combination of component c) and component d), most preferred a combination of CMC or HEMC with a starch.

The granules according to the first aspect of the invention contain a) at least one manganese bleaching catalyst of general formula (A1) defined hereinafter or a precursor thereof selected from the group consisting of a chelating ligand L or L-BG-L, a mono- to hexa-protonated salt of a chelating ligand L or L-BG-L, wherein L is a monocyclic triamine, and BG is a divalent organic bridge group.

Preferred granules contain as component a) at least one manganese bleaching catalyst of general formula (A1) defined hereinafter or a precursor thereof selected from the group consisting of a mono- to hexa-protonated salt of a chelating ligand L or L-BG-L.

The bleaching catalyst a) comprises at least one ligand of formula (I) or two ligands of formula (I) linked via an organic bridge group BG hereinafter defined. Typical ligands of formula (I) contain 3 or 6 nitrogen atoms, which atoms coordinate to a manganese ion of the catalyst.

Manganese bleaching catalysts a) are complexes of the general formula (A1)

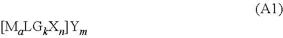

in which:
M represents a ion independently selected from Mn(II), Mn(III), or Mn(IV),
LG independently represents a nitrogen donor ligand L or L-BG-L, in which L is a monocyclic triamine and BG is a divalent organic bridge group, preferably at least one of the ligands LG is a ligand of formula (I) or two ligands of formula (I) linked via an organic bridge group BG as described herein,
X independently represents a coordinating species selected from any mono-, bi- or tri-charged anions and any neutral molecules able to coordinate a manganese ion in a mono, bi or tridentate manner, preferably selected from O²⁻, R^{a}BO₂²⁻, R^{a}COO⁻, R^{a}CONR⁻, OH⁻, NO₃⁻, NO, S²⁻, R^{a}S⁻, PO₄³⁻, PO₃OR^{a3-}, H₂O, CO₃²⁻, HCO₃⁻, R^{a}OH, N(R^{a})₃, R^{a}OO⁻, O₂²⁻, O₂⁻, R^{a}CN, Cl⁻, Br⁻, OCN⁻, SCN⁻, N₃⁻, F⁻, I⁻, R^{a}O⁻, ClO₄⁻, and CF₃SO₃⁻, and more preferably selected from O², R^{a}BO₂²⁻, R^{a}COO⁻, OH⁻, NO₃⁻, S²⁻, R^{a}S⁻, PO₄³⁻, H₂O, CO₃²⁻, HCO₃⁻, R^{a}OH, N(R^{a})₃, Cl⁻, Br⁻, OCN⁻, SCN⁻, R^{a}CN, N₃⁻, F⁻, I⁻, R^{a}O⁻, ClO₄⁻, and CF₃SO₃⁻;
each R^{a} independently represents a group selected from hydrogen, hydroxyl, —R″ and —OR″, wherein R″ is selected from C₁-C₂₀-alkyl, C₂-C₂₀-alkenyl, C₁-C₂₀-heterocycloalkyl, C₆-C₁₀-aryl, C₆-C₁₀-heteroaryl, (C═O)H, (C═O)-C₁-C₂₀-alkyl, (C═O)-C₆-C₁₀-aryl, (C═O)OH, (C═O)O—C₁-C₂₀-alkyl, (C═O)O—C₆-C₁₀-aryl, (C═O)NH₂, (C═O)NH(C₁-C₂₀-alkyl), (C═O)NH(C₆-C₁₀-aryl), (C═O)N(C₁-C₂₀-alkyl)₂, (C═O)N(C₆-C₁₀-aryl)₂, R″ being optionally substituted by one or more functional groups E, wherein E independently represents a functional group selected from —F, —Cl, —Br, —I, —OH, —OR′, —NH₂, —NHR′, —N(R′)₂, —N(R′)₃+, —C(O)R′, —OC(O)R′, —COOH, —COO (Na⁺, K⁺), —COOR′, —C(O)NH₂, —C(O)NHR′, —C(O)N(R′₂, heteroaryl, —R′, —SR′, —SH, —P(R′)₂, —P(O)(R′)₂, —P(O)(OH)₂, —P(O)(OR′)₂, —NO₂, —SO₃H, —SO₃—(Na⁺, K⁺), —S(O)₂R′, —NHC(O)R′, and —N(R′)C(O)R′, wherein R′ represents C₆-C₁₀-aryl, C₇-C₂₀-arylalkyl, or C₁-C₂₀-alkyl each of which may be each of which may be optionally substituted by —F, —Cl, —Br, —I, —NH₃+, —SO₃H, —SO₃⁻(Na⁺, K⁺), —COOH, —COO—(Na⁺, K⁺), —P(O)(OH)₂, or —P(O)(O—(Na⁺, K⁺))₂, and preferably each R^{a} independently represents hydrogen, C₁-C₂₀-alkyl or optionally C₁-C₂₀alkyl-substituted C₆-C₁₀-aryl, more preferably hydrogen or optionally substituted phenyl or naphthyl, or C₁₋₄-alkyl;
Y is an anion selected from the group consisting of halide, nitrate, thiocyanate, sulfate, sulfate monoester, sulfonate, monocarboxylate, dicarboxylate and dicarboxylate monoester, preferably an anion selected from the group consisting of chloride, bromide, nitrate, sulfate, acetate, tosylate and benzoate and most preferred selected from the group consisting of NO₃⁻-, SO₄²⁻, Cl⁻, acetate, tosylate or benzoate,
a is 1 or 2 and preferably 2;
k is an integer from 1 to 4; and preferably 1 or 2;
n is an integer from 0 to 4; and preferably 0 to 2;
m is an integer from 1 to 8, preferably from 1 to 2.

The counter anions Y in formula (A1) balance the charge on the complex formed by the chelating ligand(s) LG, manganese ion(s) M and coordinating species X. According to this invention the charge on the complex is positive, and Y is anion as defined above. Preferably, the manganese ion-containing bleaching catalyst a) is a catalyst salt comprising one or two manganese ions and one or more anions Y.

Preferably, counter anion Y is selected from the group consisting of chloride, bromide, nitrate, sulfate, acetate, tosylate and benzoate and more preferred selected from the group consisting of NO₃⁻, SO₄²⁻, Cl⁻, acetate, tosylate or benzoate and most preferred SO₄²⁻ and Cl⁻.

Most manganese complexes of formula A1 are water-soluble; thus these complexes have a solubility in water of 25° C. of at least 30 g/L, preferably a solubility in water of 25° C. of at least 70 g/L.

Ligand L of component a) is a monocyclic triamine of formula (I) and ligand L-BG-L is two monocyclic triamines of formula (I) linked via a divalent organic bridge group BG

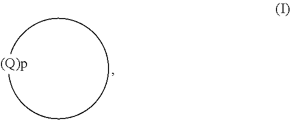

wherein:
Q is —NR—CR¹R²—CR³R⁴— or —NR—CR¹R²—CR³R⁴—CR⁵R⁶—
p is 3;
R is independently selected from the group consisting of hydrogen, C₁-C₂₄alkyl, CH₂CH₂OH and CH₂COOH; or one R is linked as a divalent group RB to the nitrogen atom of another Q of another ring of formula (I), wherein RB is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups;
R¹, R², R³, R⁴, R⁵ and R⁶ are independently selected from H, C₁-C₄alkyl and C₁-C₄-alkylhydroxy.

According to other embodiments, each R is independently selected from the group consisting of hydrogen, C₁-C₆-alkyl, CH₂CH₂OH and CH₂COOH; or one R is linked to the nitrogen atom of another Q of another ring of formula (I) via an ethylene or a propylene bridge.

According to other embodiments, each R is independently selected from CH₃, C₂H₅, CH₂CH₂OH and CH₂COOH.

Where one R is linked to the nitrogen atom of another Q of another ring of formula (I), this is typically via an ethylene bridge. In such embodiments, the other R groups, including those in the other ring of formula (I), are the same, typically C₁-C₆-alkyl, in particular methyl.

According to further particular embodiments, including each of those particular embodiments described in the preceding paragraphs, R¹, R², R³, R⁴, R⁵ and R⁶ are independently selected from hydrogen and methyl, in particular embodiments in which each of R¹, R², R³, R⁴, R⁵ and R⁶ is hydrogen.

When a compound of formula (I) comprises one group R linked to the nitrogen atom (i.e. N) of another Q of another ring of formula (I) via a bridge, it will be understood that such compounds of formula L-BG-L in particular embodiments comprising an ethylene bridge may alternatively be represented by the following structure:

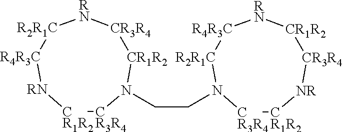

wherein R, R¹, R², R³, and R⁴ are as herein defined, including the various specific embodiments set out.

Bridge BG is preferably a C₂-C₆ alkylene bridge, preferably linking two monocyclic polyamines of formula (I). Such alkylene bridges are typically although not necessarily straight chain alkylene bridges as discussed below.

They may, however, be cyclic alkylene groups (e.g. the bridge may be cyclohexylene). Where the bridge BG is a C₆-C₁₀ arylene bridge, this may be, for example, phenylene or the corresponding arylene formed by abstraction of two hydrogen atoms from naphthalene. Where the bridge comprises one or two C₁-C₃ alkylene units and one C₆-C₁₀ arylene unit, such bridges may be, for example, —CH₂C₆H₄CH₂— or —CH₂C₆H₄—. It will be understood that each of these bridges may be optionally substituted one or more times, for example once, with independently selected C₁-C₂₄ alkyl (e.g. C₁-C₁₈ alkyl) groups.

In the compounds L-BG-L, preferably in those with L being a triamine of formula (I), the bridge is typically a C₂-C₆ alkylene bridge. Where this is so, the bridge is typically a straight chain alkylene, e.g. is ethylene, n-propylene, n-butylene, n-pentylene or n-hexylene. According to particular embodiments, the C₂-C₆ alkylene bridge is ethylene or n-propylene. According to still more particular embodiments, the C₂-C₆ alkylene bridge is ethylene.

Ligands of formula (I) form complexes with, for example, one or preferably two manganese ions, which complexes may be, or constitute part of, the bleaching catalyst.

In an alternative embodiment the granules of this invention contain as component a) a chelating ligand of formula (I) as a precursor of a bleaching catalyst.

In still another alternative embodiment the granules of this invention contain as component a) a mono- to hexaprotonated salt of a chelating ligand of formula (I) as a precursor of a bleaching catalyst.

If the cyclic triamine compound L or L-BG-L is protonated when present as component a) in the granules of the invention one of the nitrogen atoms of each polyamine ring can be protonated, i.e. the ligand L is in that case monoprotonated. Alternatively, two of nitrogen atoms of each triamine ring can be protonated, i.e. the ligand L is then diprotonated. Yet, alternatively, each of the nitrogen atoms can be protonated, i.e. the ligand is in that case triprotonated. The first pKa of 1,4,7-trimethyl-1,4,7-triazacyclononane is 11.7, the second one is 5.1, and the third one is 0.4 (P. Chauduri, K. Wieghardt, Prog. Inorg. Chem., 35, 329-436 (1987)).

In case a mono- to hexaprotonated salt of a chelating ligand L or L-BG-L, preferably of formula (I) is present as component a) the granule preferably contains no or up to 100 ppm of transition metal compounds

Examples of preferred ligands of formula (I) are triamine ligands selected from the group consisting of 1,4,7-triazacyclononanes, 1,4,7-triazacyclododecanes, 1,4,8-triazacyclododecanes, 1,4,7-trimethyl-1,4,7-triazacyclononanes and 1,4,7-trimethyl-1,4,7-triazacyclododecanes. At the nitrogen atom and/or at the CH— group these compounds can carry further substituents.

Preferred ligands of formula (I) are the following cyclic polyamines: 1,4,7-trimethyl-1,4,7-triazacyclononane (1,4,7-Me₃TACN), 2-methyl-1,4,7-triazacyclononane (2-MeTACN), 1,4-dimethyl-1,4,7-triazacyclononane (Me₂TACN), 1,2,4,7-tetramethyl-1,4,7-triazacyclononane (1,2,4,7-Me₄TACN), 1,2,2,4,7-pentamethyl-1,4,7-triazacyclononane (1,2,2,4,7-Me₅TACN), 2-benzyl-1,4,7-trimethyl-1,4,7-triazacyclononane, and 2-decyl-1,4,7-trimethyl-1,4,7 -triazacyclononane or 1,2-bis(4,7-dimethyl-1,4,7-triaza-cyclonan-1-yl)-ethane (Me₄DTNE).

These cyclic triamines are compounds known as ligands for metal complexes and can be synthesized according to standard operations of organic chemistry.

According to particular embodiments of the invention, the ligand L of formula (I) is 1,4,7-trimethyl-1,4,7-triazacyclononane (Me₃TACN) or the compound L-BG-L is 1,2-bis(4,7-dimethyl-1,4,7-triazacyclonon-1-yl)-ethane (Me₄-DTNE).

According to still more particular embodiments of the invention, the compound of formula (I) is Me₃TACN.

Preferred mononuclear Mn(III) and/or Mn(IV) complexes comprise one coordinating ligand of formula (I). Preferred dinuclear Mn(III) and/or Mn(IV) complexes comprise either two coordinating ligands of formula (I), or one coordinating ligand of formula (I) where this comprises one ethylene or propylene group R linked to the nitrogen atom of another Q of another ring of formula (I) via a bridge, as described herein, e.g. is Me₄DTNE.

Additionally, Mn(III) and/or Mn(IV) complexes may comprise additional coordinating ligands. For dinuclear complexes, these are typically oxide (O²⁻) or C₁-6 carboxylate ions, which bridge the two manganese ions. Where present, an alkylcarboxylate ion is typically acetate. Typically, dinuclear Mn(III) and/or Mn(IV) complexes comprise two or three bridging oxide ions. For example, dinuclear manganese ion-containing complexes may comprise two oxide ions and one acetate ion, each of which bridges the two manganese ions; or three oxide ions, each of which bridges the two manganese ions.

According to particular embodiments of all aspects of the invention, there is contemplated the use of dinuclear manganese ion-containing complexes comprising two ligands of formula (I) which do not comprise one group R linked to the nitrogen atom of another Q of another ring of formula (I) via a bridge, for example Me₃TACN, in which the manganese ions are bridged by three oxide ions. According to particular embodiments, such complexes comprise two Mn(IV) ions. For example, the complex may be [Mn^{IV}Mn^{IV}(μ-O)₃(Me₃TACN)₂]²⁺, “μ” denoting, according to convention, a bridging ligand.

Preferred components a) are manganese bleaching catalysts of formula (II) or (III)

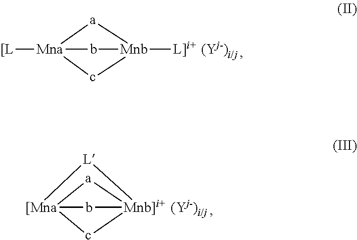

wherein
Mnₐ and Mn_{b} are manganese ions having independently of one another the oxidation number+2, +3 or +4,
L is a monocyclic ligand of formula (I) as defined above
L′ is a ligand of formula L-BG-L, wherein L is as defined above in which one R from L is linked as a divalent bridge group RB to the nitrogen atom of another L, a, b and c independently represent a coordinating species selected from any mono-, bi- or tri-charged anions and any neutral molecules able to coordinate two manganese ions in a bi- or tridentate manner, preferably selected from O²⁻, OH⁻ and H₂O,
i is 1, 2, 3, 4 or 5, preferably 1, 2 or 3,
j is 1, 2, 3 or 4,
and Y is an anion as defined above.

Particularly preferred bleaching catalysts a) are selected from the group consisting of [Mn^{IV}₂(μ-O)₃(Me₃TACN)₂]SO₄, [Mn^{IV}₂(μ-O)₃(Me₃TACN)₂](NO₃)₂, [Mn^{IV}₂(μ-I)₃(Me₃TACN)₂](tosylate)₂, [Mn^{IV}₂(μ-O)₃(Me₃TACN)₂](Cl)₂, [Mn^{IV}₂(μ-O)₃(Me₃TACN)₂](CH₃COO)₂, [Mn^{III}Mn^{IV}(μ-O)₂(μ-CH₃COO)(Me₄DTNE)]SO₄, [Mn^{III}Mn^{IV}(μ-O)₂(μ-CH₃COO) (Me₄DTNE)](NO₃)₂, [Mn^{III}Mn^{IV}(μ-O)₂(μ-CH₃COO) (Me₄DTNE)]Cl₂, [Mn^{IV}₂(μ-O)₃(Me₃TACN)₂]Cl₂ and Mn^{IV}₂(μ-O)₃(Me₃TACN)₂](Cl)₂.

Most preferred bleaching catalysts a) are selected from the group consisting of [Mn^{IV}₂(μ-O)₃(Me₃TACN)₂]SO₄, [Mn^{IV}₂(μ-O)₃(Me₃TACN)₂](NO₃)₂, [Mn^{IV}₂(μ-O)₃ (Me₃TACN)₂](tosylate)₂, and [Mn^{IV}₂(μ-O)₃(Me₃TACN)₂](Cl)₂.

As component a) the different constituents defined for this component can be used as single components or any combination of the different constituents is possible. Examples different constituents are mixtures of different manganese complex salts, mixtures of different mono- to hexaprotonated salts of a chelating ligand of formula (I), mixtures of different chelating ligands of formula (I), mixtures of manganese complex salt and mono- to hexaprotonated salt of a chelating ligand of formula (I), mixtures of manganese complex salt and chelating ligand of formula (I) or mixtures of mono- to hexaprotonated of ligand salt of formula (I) and chelating ligand of formula (I).

The granules that comprise salts as bleaching catalysts a) or as precursors of bleaching catalysts a) are generally between slightly acidic (like pH 4) and neutral, indicating that mainly the monoprotonated and diprotonated salts will be prevalent in said granules. The unprotonated ligands L and L-BG-L are very strong bases and will be readily protonated to form the monoprotonated salt in the granules if proton-donating ingredients are present in said granules. The triprotonated salt is a very strong acid and would release its third proton readily. Therefore, the triprotonated salt will likely exist only in a small portion if at all in said granules.

The monoprotonated, diprotonated, or triprotonated triamine ring of the ligand L or triamine rings of L-BG-L will have one or more counterions Anⁱ⁻ in order to balance the charge of the monoprotonated or diprotonated ligand L or L-BG-L and can be conveniently denoted as [HL]⁺(Anⁱ⁻)_{1/i}, [H₂L]²⁺(Anⁱ⁻)_{2/i}, [H₃L]³⁺(Anⁱ⁻)_{3/i}, [(HL-BG-LH)]²⁺(Anⁱ⁻)_{2/i}, [(HL-BG-LH₂)]³⁺(Anⁱ⁻)_{3/i}, [(H₂L-BG-LH₂)]⁴⁺(Anⁱ⁻)_{4/i}, [(H₃L-BG-LH₂)]⁵⁺(Anⁱ⁻)_{5/i}, and/or [(H₃L-BG-LH₃)]⁶⁺(Anⁱ⁻)_{6/i}. whereby L is a monocyclic triamine of formula (I), BG is a divalent organic bridge group, i is 1 to 4, preferably 1 or 2, and Anⁱ⁻ is an i-valent anion, preferably a mono- or divalent anion and most preferred an anion Y as defined above.

Typically, the cyclic triamine ligand will be monoprotonated or diprotonated, i.e. [HL]⁺, [H₂L]²⁺, [H₃L]³⁺, [(HL-BG-LH)]²⁺, [(HL-BG-LH₂)]³⁺, or [(H₂L-BG-LH₂)]⁴⁺. More typically, the cyclic triamine ligand will be either [HL]⁺ or [H₂L]²⁺. Even more typically, the cyclic triamine ligand will be [H₂L]²⁺.

Preferred components a) are mono- or diprotonated salts of chelating ligands of formula (I) of composition [HL]⁺(Yⁱ⁻)_{1/i}, [H₂L]²⁺(Yⁱ⁻)_{2/i} or [(HL-BG-LH)]²⁺(Yⁱ⁻)_{2/i} whereby L, BG, Y and i are as hereinbefore defined.

Preferred components a) are manganese complex salts comprising at least one chelating ligand of formula (I), very preferred mononuclear or dinuclear Mn(III) and/or Mn(IV) complexes comprising one or two ligands of formula (I) as herein defined.

In an embodiment, the granules of the invention comprise between 1 and 95 wt.-% of component a). Preferred amount of component a) in the granules is between 2 and 95 wt.-%, more preferred between 3 and 95 wt.-%, still more preferred between 50 and 95 wt.-% or between 3 and 15 wt-%, and most preferred between 70 and 95 wt.-% or between 4 and 12 wt-%.

Besides component a), the anti-agglomeration agent b), c) an/or d) and any of optional ingredients e), f) and/or g) the granules of the invention may contain one or more additional ingredients described below.

These optional ingredients are selected from the group consisting of
h) a water-soluble, film-forming polymer selected from the group consisting of polyvinylpyrrolidones, polyalkylene glycols, polyvinyl alcohols, polyacrylic acid homo- or copolymers, polymethacrylic acid homo- or copolymers or salts of these homo- or copolymers,
i) a water-soluble non-polymeric organic builder and/or an inorganic builder different from component e),
j) a water-soluble polymeric co-builder different from water soluble, film-forming polymer h),
k) water-soluble dyes or water-insoluble pigments,
l) fatty acids, esters of fatty acids, esters of carboxylic acids with fatty alcohols or waxes, and
   or a combination of at least two of ingredients h) to l), with the proviso that if co-builder j) is present then builder i) is also present.

These optional further ingredients are present in the following amounts:
0-1.5 wt-% of component h),
0-50 wt.-% of component i),
0-1.5 wt.-% of component j),
0-5 wt-% of component k), and
0-5 wt.-% of component I),
   wherein the percentages refer to the total amount of the granule, provided that, if component j) is present component i) is also present and that the total amount of components h) and j) in a granule is between 0 and 1.5 wt.-%.

Preferably the amounts of these ingredients are
0-1.0 wt.-% of component h), more preferred 0-0.5 wt-%, and most preferred 0 wt.-%,
0-40 wt.-% of component i), more preferred 0-20 wt.-%, still more preferred 0-10 wt.-%, and most preferred 0 wt.-%.
0-1.0 wt.-% of component j), more preferred 0-0.5 wt.-%, and most preferred 0 wt.-%,
0-2 wt.-% of component k), more preferred 0-1 wt-%, and most preferred 0-0.5 wt.-%, and
0-4 wt.-% of component I), more preferred 0-2 wt.-%, and most preferred 0-1 wt.-%.

Water-soluble, film-forming polymers h) are macromolecular substances that ensure the formation of a coherent film in a granule. Water-soluble, film-forming polymers h) are selected from polyvinyl-pyrrolidone homo- or copolymers such as copolymers of vinylpyrrolidone and vinyl acetate, polyvinyl alcohol homo- or copolymers, polyalkylene glycols, preferably polyethylene glycols, polyacrylic acid homo- or copolymers or polymethacrylic acid homo- or copolymers or salts of these homo- or copolymers.

The water-soluble, film-forming polymer h) may be a linear, branched or cross-linked homopolymer or copolymer, or a mixture thereof. Suitable polymers include one or more of poly(vinylpyrrolidone), polyalkylene glycol, ethylene-vinylalcohol, and linear, branched or cross-linked polymers or copolymers prepared from one or more of the following monomers: N-vinylpyrrolidone, methacrylic acid, acrylic acid, or vinyl alcohol.

Preferred polymers h) are poly (vinyl alcohol)s, (such as Mowiol® from Kuraray), functionalised poly (vinyl alcohol)s (including, for example, butyl acetals), polymers such as Kolloidon® or Luvicross® available from BASF, acrylic copolymers such as Arbopol® (homo- and copolymers of acrylic acid cross-linked with a polyalkenyl polyether) or Ultralez 10, 21, 30 or Noveon®AA-1 range from Lubrizol (acrylic acid polymer cross-linked with divinyl glycol), and the Sokalan® range from BASF (polyacrylic acid) such as CP5, CP10 and PA30.

In an embodiment, the water-soluble, film-forming polymer h) is poly(vinyl alcohol) (PVOH) or a poly(vinyl alcohol)-based polymer.

The term PVOH also covers modified polyvinylalcohol polymers which are hydrophobic or hydrophilic modified types. For example, hydrophobic polyvinylalcohol polymers include ethylene-modified ones, such as Exceval® of the firm Kuraray. Also the vinylalcohol groups may be partly modified by reaction with aldehydes, especially C₂-C₁₀ aldehydes as exemplified in WO2018/011596 or different polymer building blocks within one polymer could be used, for example polyvinylalcohol with poly-(meth)acrylate component in the polymer.

The modified residues can be block-like or statistically arranged. PVOH polymers are typically manufactured by the polymerisation of vinyl acetate to obtain poly(vinyl acetate) (PVAc) followed by hydrolysis of the PVAc.

It will be appreciated that during hydrolysis of the PVAc, a number of the vinyl acetate groups present may remain unhydrolysed in the resulting PVOH polymer. Such polymers, with a mixture of vinyl alcohol units and un-reacted vinyl acetate units, are commonly referred to by the name PVOH by those skilled in the art. The degree of hydrolysis of the PVOH is important in determining its properties.

Optionally, a second olefinic monomer, such as ethylene or propylene, may be copolymerised with the vinyl acetate and the resulting copolymers hydrolysed to create vinyl alcohol groups in the same manner. The olefinic monomer may be present in an amount from 1 to 50 mol % or 2 to 40 mol % or 5 to 20 mol % of the polymer backbone. The resulting poly(vinyl alcohol) polymers typically have modified water solubility and other physical properties compared with those derived from homopolymers of vinyl acetate. Alternatively, the olefinic monomer may be a vinylic, acrylic or methacrylic monomer,

It will be appreciated that PVOH may also be prepared by the hydrolysis of other poly(vinyl esters) such as poly(vinyl formate), poly(vinyl benzoate) or poly(vinyl ethers). Similarly a copolymer of vinyl alcohol such as poly(ethylene-vinyl alcohol) may also be prepared by copolymerising the relevant monomer with a vinyl ester other than vinyl alcohol and hydrolysing the resulting polymer for instance. Such polymers are also within the scope of the present invention.

PVOH grades with varying degrees of polymerization and hydrolysis are available under the trade name Poval® (Kuraray Chemicals) and include partly and fully saponified grades. Specific examples of fully saponified Poval® (previously called the Mowiol range) include those known as 3-85, 4-88, 4-98, 6-88, 6-98, 8-88, 10-98, 13-88, 15-99, 20-98 and 30-98 (CAS Nos: 9002-89-5). Specific examples of partly saponified Poval® include those known as 3-85 G4, 4-88 G2, 8-88 G2, 18-88 G2, 23-88 G2, 47-88 G2, 3-85, 4-88, 5-88, 6-88, 8-88, 13-88, 18-88, 23-88, 26-88, 32-88, 40-88, 44-88, 47-88, 30-92, 4-88 LA, 8-88 LA and 40-88 LA (CAS Nos: 23213-24-5). The first number in the nomenclature denotes the viscosity of the 4% aqueous solution at 20° C. as a relative measure for the molar mass of the Mowiol; the second number denotes the degree of hydrolysis of the polyvinyl acetate from which the Mowiol grade is derived. Poval© 3-85, 4-88, 4-98, 6-88 and 10-98 are particularly preferred.

In an embodiment, the water-soluble, film-forming polymer h) is a PVOH or PVOH-based polymer having degree of hydrolysis within the range 60-99%. Suitably, the water-soluble polymer is a PVOH or PVOH-based polymer having degree of hydrolysis within the range 80-99%. Such high degree of hydrolysis gives rise to favourable solubility characteristics.

In another embodiment, the water-soluble, film-forming polymer a) is a poly(vinyl alcohol)-based polymer in which a portion of the hydroxyl groups have been modified by reaction with an aldehyde. Suitably, the water-soluble, film-forming polymer h) is a poly(vinyl alcohol)-based polymer in which a portion of the hydroxyl groups have been modified by reaction with a (2-10C)aldehyde. The degree of modification of the PVOH based polymer may be from about 0.1% to about 50%, by this it is meant that the ‘OH’ portion of the PVOH has been replaced by the given percentage. The person skilled in the art will appreciate that, for example, in the case of the reaction of an aldehyde with ‘PVOH’ for each molar quantity of aldehyde two molar quantities of ‘OH’ are substituted via the acetalation reaction. Hence a 50% modified PVOH will have been reacted with 25% of a suitable aldehyde, and, of course the degree of hydrolysis of the PVOH will dictate the maximum level of substitution possible.

In another embodiment, the modified water-soluble, film-forming polymer h) is a PVOH based polymer in which at least a portion of the H atoms of the —OH groups have been exchanged for aldehyde groups (i.e. by an ester linkage). Suitably, between 0.1 and 50% of the —OH groups have been exchanged for 2-10C aldehyde groups.

In another embodiment, the water-soluble polymer is the product formed by reacting a PVOH-based polymer with a 2-10C aldehyde, such that between 0.1 Typically poly(vinylalcohol)s (PVOH) are employed, whereby the molecular weight of said polymers are typically between 1,000 and 200,000, and more typically between 20,000 and 100,000, as determined by Gel Permeation Chromatography (GPC) at 20° C., having a viscosity of at 4 wt-% of ca. 2 to 70 mPa·s, measured according to DIN 53015. Aqueous solutions of such polymers have improved handling characteristics.

Builders i) and co-builders j) are ingredients of laundry detergents and cleaning agents that soften the water, enhance the effect of surfactants and thus support the washing and cleaning performance. Builders i) and co-builders j) are able to react with calcium and magnesium ions forming the hardness in water, and to bind them for the duration of the washing and cleaning process so that no deposits form on textiles, surfaces to be cleaned or machine components. In addition, they support the washing and cleaning effect of surfactants and ensure an alkaline pH value of the wash liquor.

Component i) is a water-soluble non-polymeric organic builder or an inorganic builder.

The term “polymeric” is used in conjunction with a compound derived from polymerization of same or different monomers resulting in a compound containing recurring monomer units in a molecule. Consequently the term “non-polymeric” is used in conjunction with a compound containing no recurring monomer units in a molecule.

Water-soluble organic builders i) include non-polymeric polycarboxylic acids or their salts, such as naturally occurring hydroxycarboxylic acids, e.g. mono- or dihydroxy succinic acid, alpha-hydroxypropionic acid, gluconic acid or in particular in particular citric acid or salts thereof and sugar acids, aminopoly-carboxylic acids, in particular methylglycinediacetic acid or its salt (MGDA), glutamic di-acetic acid or its salt (GLDA), iminodisuccinic acid (IDS) and ethylenediamine-disuccinic acid or its salt (EDDS), nitrilotriacetic acid (NTA) and ethylenediamine-tetraacetic acid. Polyphosphonic acids, in particular aminotris-(methylene-phosphonic acid), ethylenediamine-tetrakis(methylene-phosphonic acid) and 1-hydroxyethane-1,1-diphosphonic acid, can also be used.

Inorganic builders i) are ion exchangers, such as alkali phosphates, poly-phosphonates, phosphonate alkyl carboxylates and preferably aluminosilicates, in particular zeolites, e.g. zeolite A, B, C, X and Y types, as well as zeolite MAP as described in EP 0 384 070 A; and precipitating builders such as sodium carbonate.

Preferred inorganic builders i) are crystalline layered silicates, e.g. builders available from Catexel under the trade name of SKS-6. Other known crystalline layered silicates are e.g. Na-SKS-1 (Na₂Si₂₂O₄₅·xH₂O, kenyaite), Na-SKS-2 (Na₂Si₁₄O₂₉·xH₂O, magadiite), Na-SKS-3 (Na₂Si₈O₁₇·xH₂O), Na-SKS-4 (Na₂Si₄O₉·xH₂O, makatite), Na-SKS-5 (α-Na₂Si₂O₅), Na-SKS-7 (μ-Na₂Si₂O₅, natrosilite), Na-SKS-9 (NaHSi₂O₅-H₂O), Na-SKS-10 (NaHSi₂O₅-3H₂O, kanemite), Na-SKS-11 (t-Na₂Si₂O₅) and Na-SKS-13 (NaHSi₂O₅). An overview of crystalline sheet-silicates is found, for example, in the article published in “Seifen-Öle-Fette-Wachse, volume 116, No. 20/1990”, on pages 805-808. Preferred builders g) are combinations of zeolites, preferably of crystalline layered silicates with nitrilotriacetic acid (NTA), phosphonates, soda, citric acid or salts thereof or methylglycinediacetic acid or its salt (MGDA).

In addition to organic and/or inorganic builders i) water-soluble polymeric polycarboxylate co-builders j) may be present.

Preferred co-builders j) are polycarboxylic acids, in particular, polyamino acids, such as polyglutamic acid or polyaspartic acid, the polycarboxylates accessible by oxidation of polysaccharides, such as starch, or dextrins, as described in WO 93/16110 A1, WO 92/18542 A1 or EP 0 232 202 A2, as well as polymeric acrylic acids, methacrylic acids, maleic acids and copolymers of these, which can also contain small proportions of polymerizable substances without carboxylic acid functionality polymerized in.

Acids used as organic builders i) and as co-builders j) are present either in the form of the free acid or in the form of their salts. In the context of the present invention, the term “organic acid” therefore includes both the organic acids in free form and in salt form. Preferred counterions of organic acids are alkali ions and in particular Na ions.

Preferred organic builders i) as non-polymeric organic acids are citric acid, ascorbic acid, oxalic acid, adipic acid, sebacic acid, malonic acid, succinic acid, glutaric acid, malic acid, tartaric acid, lactic acid, maleic acid, fumaric acid, sugar acids, aminocarboxylic acids, C₈-C₂₂ fatty acids, and mixtures thereof.

Particularly preferred non-polymeric organic acids i) are oxalic acid, ascorbic acid, citric acid and methylglycinediacetic acid or salts of these acids.

Most preferred non-polymeric organic acids i) are salts of citric acid, in particular sodium citrate, both anhydrous trisodium citrate and trisodium citrate dihydrate, can also be used or methylglycinediacetic acid or its salt.

If a granule contains a water-soluble, film-forming polymer h) and a water-soluble polymeric co-builder j) these ingredients are selected to differ from each other.

Water-soluble dyes or water-insoluble pigments k) are known to the skilled artisan. These components have already been used as constituents of granules.

Suitable fatty acids I) have 8 to 22 carbon atoms. These are, for example, lauric acid, myristic acid, palmitic acid, stearic acid or mixtures thereof. Esters of these fatty acids, e.g. methyl esters, ethyl esters or triglycerides can also be used. As an alternative esters of carboxylic acids with fatty alcohols can also be used. Fatty alcohols are aliphatic alcohols having 8 to 22 carbon atoms.

Suitable waxes I) include different organic compounds that are lipophilic, malleable solids at 25° C. These include higher alkanes, with melting points above 40 C. Natural waxes, plant-based or animal based, or synthetically produced waxes can be used. Examples of synthetically produced waxes are petroleum-derived waxes, montan waxes or polyethylene waxes.

Very preferred are granules consisting of component a), the anti-agglomeration agent b), c) and/or d) and optional ingredients e), f), g), h), i), j), k) and/or I) only.

Most preferred are granules consisting of component a) and the anti-agglomeration agent(s) b), c) and/or d) only.

The granules of the invention are uncoated.

Preferred are granules containing 3-95 wt.-% of component a) and at least one of components b) and/or c) as anti-agglomeration agent and optionally at least one of components f) and/or g), preferably only component b) or component c) as an anti-agglomeration agent.

Also preferred are granules containing 26-95 wt.-% of component a) and 5-74 wt.-% of component d) as an anti-agglomeration agent, consisting only of components a) and c).

Preferred are granules containing 5-15 wt.-% of component a) and 95-50 wt.-% of component b), preferably TAED.

Preferred are granules containing 2-25 wt.-% of component a), 50-80 wt.-% of component b), 5-15 wt.-% of component c), 10-30 wt.-% of component d) and 0-1.5 wt.-% of component h), preferably 3-15 wt.-% of component a), 55-70 wt.-% of component b), 5-15 wt.-% of component c), 15-30 wt.-% of component d) and 0-1.4 wt.-% of component h), and most preferred 3-12 wt.-% of component a), 60-70 wt.-% of component b), 5-15 wt.-% of component c), 20-30 wt.-% of component d) and 0-1.2 wt.-% of component h).

Very preferred are granules containing component c) as an anti-agglomeration agent.

Preferred granules contain no acidic components, more preferred no components containing carboxylic acid groups, sulfonic acid groups and/or their salts.

Preferred granules contain 2-25 wt.-% of component a), 2-30 wt.-% of component c), 5-30 wt.-% of component d) and 0-1.5 wt.-% of component h), most preferred 3-12 wt.-% of component a), 5-15 wt.-% of component c), 10-30 wt.-% of component d) and 0-1.4 wt.-% of component h).

In another preferred embodiment the granules contain 70-95 wt.-% of component a) and 2-30 wt.-% of component d) or 70-95 wt.-% of component a) and 5-30 wt.-% of component c).

The granules of the invention are available as granular or tablet-shaped preparations which can be prepared in a known manner, for example by mixing, granulating and/or roll compacting of the thermally resilient components and then by adding the more sensitive components, for example enzymes and the bleach catalyst.

The granules of the invention are shaped solids including tablet-shaped solids.

The production of the granules of the invention can be carried out according to methods known per se and has already been described in detail in the above-mentioned patent documents. There are different granulation methods available.

Bulk density and size of the granules can be controlled via the composition, the process condition or both, as is known in the art.

In a process variant, building-up of the granules takes place in a mixing apparatus. The components are processed in usual mixing devices operating batch-by-batch or continuously, which are usually equipped with rotating mixing organs. When mixing, all mixing variants are conceivable, which ensure a sufficient mixing of the components.

In a preferred embodiment, all components are mixed at the same time. However, multi-stage mixing processes are also conceivable, in which the individual components are entered in the overall mixture individually or together with other additives in different combinations.

The order of slow and fast mixers can be exchanged according to requirements. The dwell times in the mixer granulation are preferably 0.5 s to 20 min, especially preferred 2 s to 10 min. The granulation fluid can be pumped into the mixing apparatus via simple conduction tubes. For better distribution, however, nozzle systems (single- or multi-material nozzles) are also conceivable.

Typically, a drying step follows the granulation stage to avoid conglutination of the granules. Then, by sieving the coarse grain parts and the fine grain parts are separated. The coarse grain content is crushed by grinding and, like the fine grain content, is fed to a new granulation process. The application of a coating is preferably provided in a fluidized bed apparatus, for example in a fluidized bed mixer.

In another embodiment solutions are intensively mixed with powdery active substances and other additives optionally present, resulting in a plastically deformable mass. The mixing step can be performed in the above-mentioned mixing apparatus, but also kneaders or special extruder types are conceivable. The granulation mass is then pressed by means of tools through the nozzle holes of a press matrix, creating cylindrically shaped extrudates. The exiting extrudates must be crushed to the desired length or particle size by a post-processing step. In many cases, a length/diameter ratio of L/D=1 is desired. For cylindrical granules, the particle diameter is typically between 0.2 and 2 mm, preferably between 0.5 and 0.8 mm, the particle length is in the range of 0.5 to 3.5 mm, ideally between 0.9 and 2.5 mm. The length or size adjustment of the granules can be obtained, for example, by fixed stripper knives, rotating cut knives, cut wires or blades. To round off the cutting edges, the granules can then be rounded again in a rondier.

After the size adjustment of the granules, often a final solidification step is required in which the solvent is removed and a coating is applied. This step is usually carried out in a fluidized bed apparatus, which is operated as a dryer. Then, by sieving the coarse grain part and the fine grain part is separated. The coarse grain content is crushed by grinding and, like the fine grain content, is fed to a new granulation process. After that, the generated granules may be equipped with a coating in a fluidized bed apparatus, for example in a fluidized bed mixer.

Preferred granules of the invention are also characterized by a water content of less than 6% by weight (measured by Karl Fischer), based on the total amount of granules, especially preferred 0 to 4% by weight.

For the preparation of the granules of the invention in tablet form, preferably all components are combined in a mixer and mixed with each other. Subsequently, the mixture is compacted by means of conventional tablet presses, for example using eccentric presses or rotary presses with pressures in the range between 200×10⁵ Pa and 1500×10⁵ Pa.

One thus obtains easily break-resistant tablets which are under application conditions sufficiently quickly soluble and which have flexural strengths of normally more than 150 N. Preferably, a tablet produced in this way has a weight of 15 to 40 g, in particular from 20 to 30 g, with a diameter of 35 to 40 mm.

The preparation of the granules of the invention with high bulk densities in the range of 800 to 1000 g/I can be carried out in that in a first process sub-stage the builder components are mixed with at least a proportion of liquid mixture components by increasing the bulk density of this premixture and subsequently—if desired after an intermediate drying—the further components of the composition, including the bleach catalyst, are combined with the thus obtained premixture.

Appropriate conditions such as durations of and temperatures for the contacting will depend on the nature of the reactants (the salt of the compound L or L-BG-L, and other ingredients to obtain suitable granules) and their quantities and can be established without undue burden by the skilled person. For example, durations of contacting may be between about 1 min and about 24 hours. Often, the contacting can be carried out at ambient temperature, for example at about 20 to 25° C. although elevated temperatures, for example between about 25 and about 50° C. may be used if desired.

The invention also relates to a bleaching formulation comprising a granule described above and a peroxy compound or a precursor of a peroxy compound.

Where a peroxy compound is present in a bleaching formulation comprising granules of the invention, this may be, and typically is, a compound which is capable of yielding hydrogen peroxide in aqueous solution. Suitable amounts of peroxy compounds included within the bleaching formulation may be determined by the skilled person although typical quantities will be within the range of 1-35 wt.-%, for example 5-25 wt.-%, based on the solids content of the bleaching formulation. One of skill in the art will appreciate that smaller quantities of peroxy compounds may be used where the bleaching formulation comprises a bleaching system (discussed below) comprising a peroxy compound and a so-called bleach precursor.

Suitable hydrogen peroxide sources are well known in the art. Examples include the alkali metal peroxides, organic peroxides such as urea peroxide, and inorganic persalts, such as alkali metal perborates, percarbonates, perphosphates, persilicates, and persulfates. Typical peroxy compounds included within bleaching formulations are persalts, for example optionally hydrated sodium perborate (e.g. sodium perborate monohydrate and sodium perborate tetrahydrate) and sodium percarbonate. Use of sodium percarbonate is most advantageous for environmental reasons.

Organic peroxy acids may also serve as the peroxy compound. These may be mono- or diperoxyacids. Typical mono- or diperoxyacids are of the general formula HOO—(C═O)—R—Z, wherein R is an alkylene or substituted alkylene group containing from 1 to about 20 carbon atoms, optionally having an internal amide linkage or a phenylene or substituted phenylene group; and Z is hydrogen, halogen, alkyl, aryl, an imido-aromatic or non-aromatic group, a COOH or (C═O)OOH group or a quaternary ammonium group.

Typical monoperoxy acids include peroxy benzoic acids, peroxy lauric acid, N,N-phtaloylaminoperoxy caproic acid (PAP) and 6-octylamino-6-oxo-peroxyhexanoic acid. Typical diperoxy acids include for example: 1,12-diperoxydodecanoic acid (DPDA) and 1,9-diperoxyazeleic acid.

Peracetic acid solution can also be used as oxygen source. As well as organic peroxyacids, inorganic peroxyacids are also suitable, for example potassium monopersulfate (MPS).

If organic or inorganic peroxyacids are included within bleaching formulations, the amount of them incorporated in a bleaching formulation will typically be within the range of about 2-10 wt.-%, for example 4-8 wt.-%.

The bleaching formulation need not comprise a peroxy compound, however: a bleaching formulation of the invention may instead comprise a bleaching system constituted by components suitable for the generation of hydrogen peroxide in situ, but which are not themselves peroxy compounds. An example of this is the use of a combination of a C₁₋₄ alcohol oxidase enzyme and a C₁₋₄ alcohol, for example a combination of methanol oxidase and ethanol. Such combinations are described in WO 95/07972 A1.

Often, a bleaching species is generated in situ. For example, organic peroxyacids are often generated in situ, as opposed to being included within the bleaching formulation, peroxyacids themselves tending to be insufficiently stable. For this reason, bleaching formulations often comprise a bleaching system comprising a persalt (e.g. sodium perborate (optionally hydrated) or sodium percarbonate), which yields hydrogen peroxide in water; and a so-called peroxy bleach precursor capable of reacting with the hydrogen peroxide to generate an organic peroxyacid.

The skilled person is very familiar with the use of bleaching systems comprising peroxy bleach precursors, peroxy bleach precursors being well known to the skilled person and described in the literature. For example, reference in this regard is made to British Patents 836988, 864,798, 907,356, 1,003,310 and 1,519,351; EP 0 185 522 A, EP 0 174 132 A, EP 0 120 591 A; and U.S. Pat. Nos. 1,246,339, 3,332,882, 4,128,494, 4,412,934 and 4,675,393. Suitable bleach precursors have been listed above.

Where used, bleach precursor compounds are typically present in the bleaching formulation in an amount of up to 12 wt.-%, for example from 2-10 wt.-%, of the composition, based on the solids content of the bleaching formulation.

Peroxy compounds or bleaching systems as described herein can be stabilised within the bleaching formulation by providing them with a protective coating, for example a coating comprising sodium metaborate and sodium silicate.

As will be appreciated by the person skilled in the art, it may be desirable to subject granules according to the first aspect of the invention to further processing, for example to include the granules in the bleaching formulations of the invention.

Thus the bleaching formulation of the invention may be in the form of non-friable granules comprising the granules according to the first aspect of the invention, optionally with additional inert solid, bleach precursor, filler and salt, and with a coating agent. Definitions and descriptions of each essential and optional class of ingredients are given in the detailed description section above.

The granules according to the first aspect of the invention are typically present in bleaching formulations according to the second aspect in a solid form with mean particle sizes typically between 50 and 2500 μm, for example between 100 and 1600 μm. Particle sizes may be measured by a laser diffraction particle size analyser, for example a Malvern HP equipped with a 100 mm lens.

Moreover, the invention relates to a detergent or cleaning agent comprising a nonionic and/or an anionic surfactant and a granule described above of or a bleaching formulation described above, preferably a laundry detergent or a dishwashing agent.

The granules according to the invention are preferably used for the production of detergents or cleaning agents.

The detergents and cleaning agents according to the invention can be present as granules, powdered or tablet-like solids, but also in liquid or paste-like form in pouches and more-chamber bottles.

Preferably, the detergents and cleaning agents according to the invention are solids in powder or tablet form, in particular powders.

In addition to the granules and non-ionic and/or anionic surfactants and bleaching agents or bleaching agent precursors, the detergents and cleaning agents according to the invention may in principle contain all known ingredients that are customary in such agents.

The detergents and cleaning agents according to the invention contain nonionic and/or anionic surfactants, preferably anionic surfactants and/or low-foaming nonionic surfactants. These serve to improve the removal of greasy soiling, as wetting agents and, if necessary, as granulation aids in the production of these agents. Their amount can be up to 40% by weight, preferably up to 20% by weight and is particularly preferably in the range of 1 to 10% by weight, based on the total weight of the detergent or cleaning agent.

Anionic surfactants contain anionic functional groups at their head, such as sulfate, sulfonate, phosphate and carboxylate. Examples include ammonium lauryl sulfate, sodium lauryl sulfate, such as sodium dodecyl sulfate, the related alkylether sulfates, such as sodium lauryl ether sulfate, secondary alkane sulfonate, alkylbenzene sulfonates, dioctyl sodium sulfosuccinate, perfluoro-octanesulfonate, perfluorobutanesulfonate, alkyl-aryl ether phosphates, alkyl ether phosphates or carboxylates, such as carboxylate salts (soaps) of fatty acids, e.g. sodium stearate.

Non-ionic surfactants have covalently bonded oxygen-containing hydrophilic groups, which are bonded to hydrophobic parent structures. The water-solubility of the oxygen groups is the result of hydrogen bonding which decreases with increasing temperature. Non-ionic surfactants are less sensitive to water hardness than anionic surfactants, and they foam less strongly. Examples include ethoxylates, such as fatty alcohol ethoxylates, alkylphenol ethoxylates, fatty acid ethoxylates, ethoxylated amines or fatty acid amides, terminally blocked ethoxylates, fatty acid esters of polyhydroxy compounds, fatty acid esters of glycerol, fatty acid esters of sorbitol, fatty acid esters of sucrose, alkyl poly glucosides (APGs), sophorolipids and rhamnolipids.

Preferably, low-foaming surfactants are used. These preferably include fatty alcohol polyethylene glycol polypropylene glycol ethers or fatty alcohol polyethylene glycol polybutylene glycol ethers, end-capped alkyl polyalkylene glycol mixed ethers. Also suitable are surfactants from the glucamide family, such as alkyl N-methyl glucamides, in which the alkyl part is preferably derived from a fatty alcohol. The presence of amine oxides, betaines and ethoxylated alkylamines is also possible.

The detergents and cleaning agents according to the invention, in particular the laundry detergents and agents for cleaning dishes, may contain, in addition to the above-mentioned ingredients, in particular builders, enzymes, alkali carriers, pH regulators, organic solvents and other auxiliaries, such as glass corrosion inhibitors, silver corrosion inhibitors and foam regulators.

In principle, all builders commonly used in detergents and cleaning agents can be used. These are known to the skilled person. Examples of builders are given in the description of components g) and h).

In principle, all enzymes commonly used in detergents and cleaning agents can be used. Examples of these are listed above under component h) and are known to the person skilled in the art. Enzymes can be adsorbed on carriers and/or embedded in coating substances in order to protect them against premature inactivation. Enzymes can also be incorporated into the granules according to the invention. They are usually contained in the detergents and cleaning agents according to the invention in amounts of 0 to 10% by weight and preferably in amounts of 0.05 to 5% by weight, whereby enzymes stabilized against oxidative degradation are particularly preferred.

The alkali carriers used in the detergents and cleaning agents according to the invention are compounds normally used for this purpose and known to the skilled person. Examples of alkali carriers are alkali silicates, alkali carbonates and/or alkali hydrogen carbonates. Alkali carriers can be present in quantities of up to 40% by weight, in particular from 3 to 30% by weight, based on the total weight of the detergent and cleaning agent.

In order to adjust a desired pH value which does not result automatically from the mixture of the other components, the washing and cleaning compositions according to the invention may contain acids, in particular citric acid, acetic acid, tartaric acid, malic acid, lactic acid, glycolic acid, succinic acid, glutaric acid and/or adipic acid, but also mineral acids, in particular sulphuric acid or alkali hydrogen sulphates, or bases, in particular ammonium or alkali hydroxides. Such pH regulators are preferably present in quantities of up to 10% by weight, based in each case on the total weight of the detergent and cleaning agent.

Organic solvents include alcohols with 1 to 4 carbon atoms, in particular methanol, ethanol, isopropanol and tert. Butanol, diols with 2 to 4 C atoms, in particular ethylene glycol and propylene glycol, as well as mixtures thereof and the ethers derivable from the aforementioned compound classes. Such water-miscible solvents are preferably present in the washing and cleaning compositions according to the invention in an amount not exceeding 20% by weight and particularly preferably from 1 to 15% by weight.

The washing and cleaning compositions according to the invention may contain as further ingredients, for example, sequestering agents known from the prior art for such compositions, electrolytes, additional peroxygen activators, colorants or fragrances, such as perfume oils.

The skilled person will be readily able to formulate a suitable detergent or cleaning agent, e.g. for use in dishwash cleaning or laundry cleaning in accordance with his normal skill. Such formulations may, for example, comprise additional metal-ion based bleach catalysts or organic bleach catalysts suitable for catalysing the activity of the peroxy compounds described herein.

For dishwash cleaning, corrosion on glassware during the rinsing stages can be suppressed by using glass corrosion inhibitors. These are, for example, zinc salts and bismuth compounds.

To control glass corrosion, detergents and cleaning agents of the present invention, in particular dishwasher detergents, may incorporate at least one zinc salt or a bismuth compound, preferably selected from the group of organozinc salts, more preferably selected from the group of soluble organozinc salts, yet more preferably selected from the group of soluble zinc salts of monomeric or polymeric organic acids and yet still more preferably selected from the group consisting of zinc acetate, zinc acetylacetonate, zinc benzoate, zinc formate, zinc lactate, zinc gluconate, zinc oxalate, zinc ricinoleate, zinc abietate, zinc valerate and zinc p-toluenesulfonate. Bismuth compounds such as, for example, bismuth acetate, bismuth chloride or bismuth oxide are employable as an alternative to or in combination with these zinc salts.

Detergents and cleaning agents of the invention may also contain silver corrosion inhibitors for silver corrosion control. Preferred silver corrosion inhibitors are organic sulfides such as cystine and cysteine, di- or trihydric phenols, optionally alkyl- or aryl-substituted triazoles such as benzotriazole, isocyanuric acid, salts and/or complexes of titanium, of zirconium, of hafnium, of cobalt or of cerium wherein the metals referred to are present in one of the oxidation states II, III, IV, V or VI, depending on the metal.

The preparation of solid or powder detergents and cleaning agents according to the invention does not present any difficulties and can in principle be carried out in a known manner, for example by spray drying or granulation, with layered silicates such as SKS-6 and granules of the invention being added separately later, if necessary.

Detergents and cleaning agents according to the invention in the form of aqueous solutions or solutions containing other conventional solvents can be prepared particularly advantageously by simply mixing the ingredients, which can be added in substance or as a solution in an automatic mixer.

The detergents and cleaning agents according to the invention are preferably available as powdery, granular or tablet-like preparations which can be produced in a manner known per se, for example by mixing, granulating, roller-compacting and/or by spray-drying thermally loadable components and admixing the more sensitive components, which include in particular enzymes, bleaching agents and the bleaching catalyst.

Detergents and cleaning agents according to the invention can be used both for hand washing and in household washing machines or dishwashers as well as in commercial washing machines or dishwashers. They can be added by hand or by means of suitable dosing devices. The application concentrations in the cleaning liquor are generally about 1 to 8 g/I, preferably 2 to 5 g/I.

The invention also relates to a cleaning method said method comprising contacting a substrate to be cleaned with water and a bleaching formulation or a detergent or cleaning agent as defined hereinto before.

Preferably the cleaning method is a method of cleaning surfaces or dishes, in particular by using a mechanical dishwasher, the method comprising contacting the surfaces or dishes to be cleaned with water and the bleaching formulation or the cleaning agent as defined hereinto before.

Also preferred is a method of cleaning textiles or non-woven fabrics, the method comprising contacting the textiles or the non-woven fabrics to be cleaned with water and the bleaching formulation or the detergent as defined hereinto before.

The invention relates also to the use of a granule described above in a detergent or in a cleaning agent, preferably in a laundry detergent or in a dishwashing detergent.

Finally, the invention relates to the use of a ligand salt described above as a binder for granules.

The non-limiting examples below more fully illustrate the embodiments of this invention.

### Experimental

### Chemicals Used

[H₂(Me₃TACN)]Cl₂ or Me₃TACN*2HCl was prepared as described in WO 2022/122117 A1.

[Mn₂(μ-O)₃(Me₃TACN)₂]SO₄ was prepared as described in WO2006/125517 (abbreviated below as MnTACNSO₄).

TAED (Peractive® AC White) was obtained from Catexel.

Corn starch was obtained from Roth.

PVOH (polyvinyl alcohol) was obtained from Kuraray (Poval® 6-88).

Acusol 497 (a copolymer of acrylic acid and maleic anhydride) was obtained from Dow.

Methylhydroxyethylcellulose (Tylose© MH50 G) from Shinetsu GmbH.

Carboxymethylcellulose (CMC) from Nouryon.

Sodium percarbonate was obtained from Evonik Treibacher.

### PREPARATION EXAMPLES

### Examples 1-6

A typical recipe to prepare granules 1-6 disclosed hereinafter is shown for granule 1.

In an Eirich laboratory mixer (Type EL01) 37.50 g of corn starch and 200.00 g of TAED were added and mixed thoroughly at room temperature (1 minute at 23.3-24.6° C.). Then the mixture was granulated within 2 minutes with a solution of 11.60 g [H₂Me₃TACN]Cl₂ and 3.48 g PVOH 6-88 dissolved in 31.30 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Typical yields were >75%.

Granules 2-6 can be prepared using the same procedure. The composition of the granules is shown in the table below.

TABLE 1

| | | | | Corn | Acusol |
|---|---|---|---|---|---|
| Example/- | TAED | Me₃TACN*2HCl | PVOH | starch | 497 |
| granule no. | wt.-% | wt.-% | wt.-% | wt.-% | wt.-% |
| 1 | 79.2 | 4.6 | 1.4 | 14.8 | — |
| 2 | 75.6 | 10.2 | — | 14.2 | — |
| 3 | 75.6 | 10.2 | — | 14.2 | — |
| 4 | 89.3 | 10.7 | — | — | — |
| 5 | 88.2 | 10.6 | 1.2 | — | — |
| 6 | 88.2 | 10.6 | — | — | 1.2 |

### Granulation Results:

All granulations were unremarkable and produced appealing granules with satisfactory yields.

In Example 1, the concentration of the ligand salt was increased to 4.6 and resulted in 84% yield granules. Granules are stable, but tend to stick together when stored at 40° C. after 3 months.

In Example 2, the concentration was to be further increased to 10%. For this purpose, the ligand salt was added to the solid phase and granulated with water to result in a yield of 63.5%. Granules are stable and do not tend to stick together when stored at 40° C.

In Example 3, the concentration was to be kept constant at 10%, but the ligand salt was to be added to the liquid phase. In combination with PVOH this led to 2 failed experiments which clumped together. As a solution, the PVOH was removed from the aqueous phase and granulated only with ligand salt in water to result in a yield of 61.2%. Granules were fallen apart after 3 months at room temperature.

In Example 4, an attempt was made to granulate TAED powder with ligand salt in water only. This resulted in a yield of 75.7%. Granules are stable and do not tend to stick together when stored at 40° C.

In Example 5, the corn starch initially used in Examples 1-3 was omitted. This resulted in a yield of 93.4%. Granules are stable, but tend to stick together when stored at 40° C. after 3 months.

Example 6 shows the substitution of PVOH with Acusol 497. This resulted in a yield of 85.8%. Granules are stable, but tend to stick together when stored at 40° C. after 3 months.

### Summary of Granulation Results

Example 5, TAED granulated with PVOH/ligand salt solution gave the highest yield of 93.4%.

Example 6, TAED granulated with Acusol 497/ligand-salt solution gave a satisfactory yield of 85.8%.

Example 4, TAED granulated with water/ligand salt solution gave a good yield of 75.7%, but the yield could be optimized here by increasing the solution dosage. Granules are stable and do not tend to stick together when stored at 40° C.

### Examples 7-10

In these experiments it was evaluated whether a pure ligand salt granulate can be produced. If not, the maximum concentration of ligand salt is to be determined. Both compaction and wet granulation were investigated. Compacting was performed using the Atlas Autotouch® Press, Automatic Benchtop Laboratory Press.

### Example 7 (Comparative Compaction Process)

Twelve 5 g [H₂(Me₃TACN)]Cl₂ (ligand salt) tablets were pressed at a pressure of 2 t each. After determining the tablet hardness and thickness, the tablets were granulated using a Frewitt screen basket mill. The yield was 79% in the target particle size range of 200-1600 μm and defined the compaction as feasible. After sieving agglomerations appeared in the target particle size range. Granulation of 100% ligand salt is therefore problematic.

### Example 8 (Comparative Wet Granulation)

200 g [H₂(Me₃TACN)]Cl₂ were used as ligand salt. The first granulation of pure ligand salt using water in the Eirich EL01 high-shear mixer following the procedure of granule 1 was promising according to the dried granules. But after sieving, agglomerations appeared in the target particle size range of 200-1600 μm. Granulation of 100% ligand salt is therefore problematic.

### Example 9

In an Eirich laboratory mixer (Type EL01) 200.00 g of [H₂Me₃TACN]Cl₂ and 10.1 g (5%) of corn starch were added and mixed thoroughly at room temperature (1 minute at 23.0-23.7° C.). Then the mixture was granulated within 1 minute with 35.00 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Yield was 96.4%. This granule is called Granule 9. This example demonstrates that wet granulation can be realized with additional corn starch to prevent agglomeration.

### Example 10

In an Eirich laboratory mixer (Type EL01) 200.00 g of [H₂Me₃TACN]Cl₂ and 10.0 g of methylhydroxyethylcellulose were added and mixed thoroughly at room temperature (1 minute at 23.0-23.7° C.). Then the mixture was granulated within 1 minute with 35.00 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Yield was 85%.

### Example 11

In an Eirich laboratory mixer (Type EL01) 4.3% of MnTACNSO₄ solution, 17.3% of corn starch, 6,9% of CMC and 46.7% of TAED were added and mixed thoroughly at room temperature (1 minute at 23.0-23.7° C.). Then the mixture was granulated within 1 minute with 35.00 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Yield was 96.4%

### Example 12

In an Eirich laboratory mixer (Type EL01) 7% of MnTACNSO₄. 40.% of corn starch and 53% of TAED were added and mixed thoroughly at room temperature (1 minute at 23.0-23.7° C.). Then the mixture was granulated within 1 minute with 35.00 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Yield was 85%.

### Example 13

In an Eirich laboratory mixer (Type EL01) 12% of MnTACNSO₄ solution, 32% of corn starch, 8% of CMC and 58% of TAED were added and mixed thoroughly at room temperature (1 minute at 23.0-23.7° C.). Then the mixture was granulated within 1 minute with 35.00 g water. After 1 minute post-granulation the granules were dried at 60° C. for 45 minutes as a fluidized bed. The particles thus obtained were then sieved to obtain a particle size from 1.6 mm to 0.2 mm. Fines (<0.2 mm) and coarse granules (>1.6 mm) were discarded or could be re-used to prepare new granules of the right size. Yield was 85%.

Examples 9-13 demonstrate that wet granulation can be realized with Mn bleach catalyst salt and TAED using corn starch and optionally CMC to prevent agglomeration.

### Example 14

In an Eirich laboratory mixer (Type EL01) 12.60 g of MnTACNSO₄ (4.36%) as a 15 wt.-% solution in water, 50.0 g of corn starch (17.30%), 135 g of TAED (46.71%) and 20 g of carboxymethylcellulose (CMC, 6.92%) were added and mixed thoroughly at room temperature (1 minute at 23.0-23.7° C.). Then the mixture was granulated within 1 minute with addition of water to give a total of 73 g (25%) of water. After 1 minute post-granulation the granules were dried at 60° C. for 40 minutes as a fluidized bed. The particles thus obtained were then sieved to obtain a particle size from 1.25 mm to 0.2 mm. Fines (<0.2 mm) and coarse granules (>1.25 mm) were discarded or could be re-used to prepare new granules of the right size. Yield was 92.26%. Composition of the dried granules was as follows (in wt.-%):

MnTACNSO₄ (5.79), TAED (62.04), CMC (9.19) and corn starch (22.98).

### Example 15(Comparative Example)

Granules comprising 6.0% of MnTACNSO₄, 39.6% of microcrystalline cellulose, 1.6% of polyvinyl alcohol and 52.9% of CaSO₄ were prepared as disclosed in WO 2022/058039 A1. These granules correspond to granules 7 in WO 2022/058039 A1.

The aqueous solution comprising the PVOH had a viscosity at 25° C. over 500 mPas Brookfield RVT II Spindle 4, at 20° C. When adding said aqueous PVOH solution by spraying this into the Eirich laboratory mixer instead of adding the PVOH solution into the mixing device granulation is equal in the lab. But spraying can inhibit nozzles in continuous production.

### Application Examples

### Storage Stability Tests and Bleaching Tests of Granules 1-6 and Granule 9 in Laundry Detergent Formulation 1

The granules from Examples 1-6 were tested for their BC-1 tea-stain bleaching activity at 7.5 ppm level. A commercial laundry detergent formulation (OMO Colour©) 5 g/L, sodium percarbonate (0.5 g/L) and 2.5 ppm Me₃TACN*2HCl was mixed (denoted as fresh in the table below). When granules were used, correction was made for the inclusion level of Me₃TACN*2HCl in each of the granules (so in all cases 2.5 ppm of Me₃TACN was in the solution). Tests were done in mini bottles (10 mL) with 1 g BC-1 stain in each bottle. The BC-1 stains were treated with the solutions for 30 min at 40° C. and were washed with demineralised water and then dried in the dark overnight. Reflectance at 460 nm before and after the wash was determined which is denoted as ΔR. A higher number means a better bleaching effect. The granules 1-6 and 9 were then stored (without OMO Colour formulation) in an oven at 40° C. and the tea-stain bleaching activity was determined 3 months storage in the same manner described above.

Additionally, storage stability tests were done using the same granules (1-6 and 9) yielding a dose level of 7.5 ppm of Me₃TACN in the solution, but now the storage duration was 6 months. Testing of bleaching activity was done using the same procedure as shown above.

The results are given in the table below. The error of the stain bleaching activity is around 1 ΔR unit.

TABLE 2

| | | ΔR | ΔR | | ΔR | ΔR |
|---|---|---|---|---|---|---|
| | | before | after | | before | after |
| | Composition | storage | storage | Composition | storage | storage |
| | of test | (2.5 | (2.5 | of test | 7.5 | (7.5 |
| Example | formulation | ppm) | ppm) | formulation | ppm) | ppm) |
| VA1 | OMO Colour + | 9.6 | not | OMO Colour + | 9.6 | Not |
| | SPC without | | tested | SPC without | | tested |
| | Me3TACN*2HCl | | | Me3TACN*2HCl | | |
| | (blank) | | | (blank) | | |
| A1 | OMO Colour + | 15.6 | 15.5 | OMO Colour + | 21.9 | 22.0 |
| | SPC with 48 | | | SPC with 144 | | |
| | mg/L granule 1 | | | mg/L granule 1 | | |
| A2 | OMO Colour + | 15.5 | 16.2 | OMO Colour + | 21.7 | 21.8 |
| | SPC with 24.5 | | | SPC with 73.5 | | |
| | mg/L granule 2 | | | mg/L granule 2 | | |
| A3 | OMO Colour + | 16.5 | 16.4 | OMO Colour + | 21.5 | 21.7 |
| | SPC with 24.5 | | | SPC with 73.5 | | |
| | mg/L granule 3 | | | mg/L granule 3 | | |
| A4 | OMO Colour + | 15.0 | 14.5 | OMO Colour + | 21.0 | 21.0 |
| | SPC with 23.4 | | | SPC with 70.2 | | |
| | mg/L granule 4 | | | mg/L granule 4 | | |
| A5 | OMO Colour + | 14.0 | 14.2 | OMO Colour + | 20.5 | 20.7 |
| | SPC with 23.6 | | | SPC with 70.8 | | |
| | mg/L granule 5 | | | mg/L granule 5 | | |
| A6 | OMO Colour + | 14.3 | 14.4 | OMO Colour + | 20.4 | 20.1 |
| | SPC with 23.6 | | | SPC with 70.8 | | |
| | mg/L granule 6 | | | mg/L granule 6 | | |
| A7 | OMO Colour + | 16.9 | 17.6 | OMO Colour + | 20.1 | 19.3 |
| | SPC with 2.63 | | | SPC with 7.89 | | |
| | mg/L granule 9 | | | mg/L granule 9 | | |

### Discussion of Results

In all cases the bleaching activity of all the granules after and before storage was very similar, showing that the granules exhibit good storage stability (both when tested for 3 months storage and 6 months storage). Whilst granules 1-6 contain mostly TAED and moderate levels of the Me₃TACN ligand salt, granule 9 has a very different composition: no TAED and a very level of ligand salt. This shows that the inclusion of a bleach precursor such as TAED is not a necessity to have it included in the granule composition.

### Storage Stability Tests and Bleaching Tests of Granules 1-6 in Laundry Detergent Formulation 2

Next storage tests were conducted in a IEC-A formulation containing sodium percarbonate and TAED (the formulation contained 1 g IEC-A, 0.15 g of SPC and 0.03 g of TAED). The amount granule stored in the solid formulation depended on the level of Me₃TACN*2HCl salt in each of the granule and was 52.4, 23.6, 23.6, 22.4, 22.6 and 22.6 mg/g IEC-A formulation.

Besides the granules 1-6 also a reference experiment was performed by using the pure Me₃TACN·2HCl salt (not granulated or compacted) as powder in the same IEC-A formulation. In all experiments, the same amount of the Me₃TACN·2HCl salt was used (which in all cases resulted in 2.4 mg of ligand salt per 200 mL wash liquor).

The bleaching Linitests were performed in 200 mL beakers using 4 BC-1 cloths (each 1.25 g). The water used was hardened-up Millipore water (15° DH, with Ca:Mg of 3:2). The BC-1 stains were treated with the solutions for 30 min at 40° C. and were washed with demineralised water and then dried in the dark overnight.

Reflectance at 457 nm (with UV filter) was determined before and after the wash. Storage was performed in an oven set at 40° C. for 12 weeks. It was observed that pure Me₃TACN·2HCl powder stored in the IEC-A formulation discoloured (yellow brown), whilst the formulations with the granules 1-6 did not change colour or appearance after storage. Each of the granule (and pure Me₃TACN·2HCl) were tested on its tea-stain bleaching activity before conducting storage and after the storage period. The results are given in the table below.

TABLE 3

| | | Delta remission | Delta remission |
|---|---|---|---|
| | | (457 nm) washed | (457 nm) washed |
| | | vs. unwashed | vs. unwashed |
| Example | | before storage | after storage |
| VB1 | IEC-A formulation | 9.3 | 8.5 |
| | without | | |
| | Me3TACN*2HCl | | |
| | (blank) | | |
| VB2 | IEC-A formulation | 12.6 | 8.0 |
| | with pure | | |
| | Me3TACN*2HCl as | | |
| | powder - 2.4 mg/g | | |
| | (reference) | | |
| B1 | IEC-A formulation | 13.0 | 13.3 |
| | with 52.4 mg/g | | |
| | granule 1 | | |
| B2 | IEC-A formulation | 12.7 | 13.2 |
| | with 23.6 mg/g | | |
| | granule 2 | | |
| B3 | IEC-A formulation | 12.7 | 13.1 |
| | with 23.6 mg/g | | |
| | granule 3 | | |
| B4 | IEC-A formulation | 12.7 | 13.5 |
| | with 22.4 mg/g | | |
| | granule 4 | | |
| B5 | IEC-A formulation | 12.6 | 13.0 |
| | with 22.6 mg/g | | |
| | granule 5 | | |
| B6 | IEC-A formulation | 12.2 | 12.0 |
| | with 22.6 mg/L | | |
| | granule 6 | | |

### Discussion of the Results

The results presented in the table above show
The IEC-A formulation without Me₃TACN·2HCl salt shows a moderate and storage-stable bleaching activity on BC-1 tea stain.
Inclusion of the pure ligand salt Me₃TACN·2HCl into the IEC-A formulation, that was not granulated or compacted, dosed as a powder shows when freshly prepared a very significant boost in the bleaching activity. However, after storage the bleaching performance is similar to that one of the blank, which suggests that the Me₃TACN*2HCl ligand salt has been degraded to a large extent.
All granules 1-6 show a similar performance as the pure Me₃TACN·2HCl salt (reference) when tested freshly, but the key difference is that the performance after storage of these granules mixed into the IEC-A formulation with SPC and TAED has not been diminished, suggesting good storage stability, also in a full detergent formulation.

### Storage Stability Tests and Bleaching Tests of Granules of Examples 14 and 15 in an Automatic Dishwash (ADW) Formulation

The granules from Example 14 and from Example 15 were tested for their tea-stain bleaching activity in a dishwasher. An ADW formulation having the composition according to the following table was combined with the granules of Example 14.

Composition of ADW formulation. Table 4.

| Ingredient | Amount (wt.-%) |
|---|---|
| sodium citrate | 36.0 |
| sodium carbonate | 25.0 |
| sodium percarbonate | 15.0 |
| TAED¹⁾ | 5.0 |
| PEG 1500 powder | 3.0 |
| PEG 6000 powder | 2.0 |
| acrylic acid homopolymer²⁾ | 5.0 |
| nonionic surfactant. based on a | 1.0 |
| saturated iso-C13-alcohol ³⁾ | |
| Protease⁴⁾ | 1.5 |
| Amylase⁵⁾ | 0.5 |
| layered sodium disilicate⁶⁾ | 5.0 |

¹⁾PERACTIVE AC white from Catexel
²⁾Sokalan PA 25CL from BASF
³⁾ Lutensol TO7 fro BASF
⁴⁾Blaze Evity 150T from Novozymes
⁵⁾Stainzyme Plus Evity 24T from Novozymes
⁶⁾SKS-6 WB from Catexel

19.8 of the ADW formulation was combined with 82 mg of granules of Example 14 (Application Example D1), with 41 mg of granules of Example 14 (Application Example D2) or with 82 mg of granules of Example 15 (Application Example CD1 according to the following procedure.

The ADW formulations comprising the granules of Examples 14 or 15, respectively, were formed into tablets of 20 g each by using a Carver Handtablettenpresse Model 4332 using a 1.5 ton press force.

### Cleaning Tests

The tablets comprising the granules of Examples 14 or 15, respectively, were tested for tea-stain removal of tea cups in an automatic dishwasher (Miele G 1223 SC GSL2) using said ADW formulation comprising the granules (45° C., standard programme R-time 2, at 21° DH water hardness, with 50 g of IKW soil—protocol. The assessment of the cleaning performance was made based on visual inspection, where 0% means no cleaning of the tea stains and 100% means complete removal of the tea stains.

The formulations of Examples D1, D2 and CD1 comprising the granules of Example 14 or 15 showed a very good cleaning performance under these conditions (complete 100% cleaning of the tea cups).

### Storage Stability Tests

The tablets comprising the granules of Examples 14 or 15, respectively, were stored for 12 weeks in an oven at 40° C. and were then tested for the cleaning performance and visually assessed (color changes of the tablets).

The ADW tablets of Examples D1 and D2 did not change color during this storage period.

The tea stain bleaching performance of the ADW tablets of Examples D1 and D2 showed complete 100% removal of the tea stains before and after storage of the ADW tablets.

The ADW tablets of Example CD1 did not change color during this storage period.

The tea stain bleaching performance of the ADW tablets of Example CD1 showed complete 100% removal of the tea stains before storage but only 60% removal after storage of the ADW tablets.

1. An uncoated granule comprising
a) 1-95 wt-% of a manganese bleaching catalyst of formula (A1), 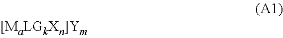
wherein
M represents a ion independently selected from Mn(II), Mn(III), or Mn(IV),
LG independently represents a nitrogen donor ligand L or L-BG-L, in which L, and L-BG-L independently represent a nitrogen donor ligand,
L is a monocyclic triamine and BG is a divalent organic bridge group,
X independently represents a coordinating species selected from any mono-, bi- or tri-charged anions and any neutral molecules able to coordinate a manganese ion in a mono, bi or tridentate manner,
Y is an anion selected from the group consisting of halide, nitrate, thiocyanate, sulfate, sulfate monoester, sulfonate, monocarboxylate, dicarboxylate and dicarboxylate monoester,
a is 1 or 2,
k is an integer from 1 to 4,
n is an integer from 0 to 4, m is an integer from 1 to 8,
an anti-agglomeration agent selected from the group consisting essentially of at least one or more of components b), c) and d), wherein
b) is a bleach activator which is present in an amount between 0 and 95 wt-%,
c) is a cellulose ether, which is present in an amount between 0 and 50 wt-%, and
d) is a polysaccharide absorbent selected from the group consisting of starch, modified starch, glycogen or natural gum, which is present in an amount between 0 and 50 wt-%,
which granule contains between 0 and 1.5 wt.-% of a water-soluble film-forming polymer selected from the group consisting of polyvinylpyrrolidones, polyalkylene glycols, polyvinyl alcohols, polyacrylic acid homo- or copolymers, polymethacrylic acid homo- or copolymers or salts of these homo- or copolymers.

2. The granule according to claim 1, wherein L is a ring of formula (I) or L-BG-L is two rings of formula (I) linked via an organic divalent group BG 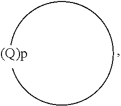
wherein:
Q is —NR—CR¹R²—CR³R⁴— or —NR—CR¹R²—CR³R⁴—CR⁵R⁶—
p is 3,
R is independently selected from the group consisting of hydrogen, C₁-C₂₄-alkyl, CH₂CH₂OH and CH₂COOH, or one R is linked as a divalent group BG to the nitrogen atom of another Q of another ring of formula (I), wherein BG is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups,
R¹, R², R³, R⁴, R⁵ and R⁶ are independently selected from H, C₁-C₄alkyl and C₁-C₄-alkylhydroxy.

3. The granule according to claim 22, wherein component a) is a mono- to hexa-protonated salt of a chelating ligand L or L-BG-L, with the proviso that the granule contains between 0 and 100 ppm of transition metal compounds, a said salt having a composition of one or more of [HL]⁺(Anⁱ⁻)_{1/i}, [H₂L]²⁺(Anⁱ⁻)_{2/i}, H₃L]³⁺(Anⁱ⁻)_{3/i}, [(HL-BG-LH)]²⁺(Anⁱ⁻)_{2/i}, [(HL-BG-LH₂)]³⁺(Anⁱ⁻)_{3/i}, [(H₂L-BG-LH₂)]⁴⁺(Anⁱ⁻)_{4/i}, [(H₃L-BG-LH₂)]⁵⁺(Anⁱ⁻)_{5/i}, and [(H₃L-BG-LH₃)]⁶⁺(Anⁱ⁻)_{6/i}, wherein L and BG are as defined in claim 22, i is 1 to 4, and Anⁱ⁻ is an i-valent anion.

4. The granule according to claim 2, wherein the ligand of formula (I) is 1,4,7-trimethyl-1,4,7-triazacyclononane (Me₃TACN) and the manganese bleaching catalyst of formula A1 contains an anion selected from the group consisting of halide, nitrate, thiocyanate, sulfate, sulfate monoester, sulfonate, monocarboxylate, dicarboxylate and dicarboxylate monoester.

5. The granule according to claim 1, wherein the bleaching catalyst a) is selected from the group consisting of [Mn^{IV}₂(μ-O)₃(Me₃TACN)₂]SO₄, [Mn^{IV}₂(μ-O)₃(Me₃TACN)₂](NO₃)₂, [Mn^{IV}₂(μ-O)₃(Me₃TACN)₂](tosylate)₂, [Mn^{IV}₂(μ-O)₃(Me₃TACN)₂](Cl)₂, [Mn^{IV}₂(μ-O)₃(Me₃TACN)₂](CH₃COO)₂, [Mn^{III}Mn^{IV}(μ-O)₂(μ-CH₃COO)(Me₄DTNE)]-SO₄, [Mn^{III}Mn^{IV}(μ-O)₂(μ-CH₃COO)(Me₄DTNE)](NO₃)₂, [Mn^{III}Mn^{IV}(μ-O)₂(μ-CH₃COO)(Me₄DTNE)]Cl₂, [Mn^{IV}₂(μ-O)₃(Me₃TACN)₂]Cl₂ and Mn^{IV}₂(μ-O)₃(Me₃TACN)₂](Cl)₂.

6. The granule according to claim 1, wherein component c) is selected from the group consisting of one or more of methyl cellulose (MC), ethyl cellulose (EC), hydroxy methyl cellulose (HMC), hydroxyethyl cellulose (HEC), hydroxypropyl cellulose (HPC), methyl ethyl cellulose (MEC), hydroxyethyl methyl cellulose (HEMC), hydroxypropyl methyl cellulose (HPMC) ethyl hydroxyethyl cellulose and carboxymethyl cellulose (CMC).

7. The granule according to any of claims 1 to 6, wherein component c) is a cellulose ether containing no carboxyl groups,

8. The granule according to claim 1, wherein the anti-agglomeration agent is a combination of component c) and component d).

9. The granule according to claim 1, wherein the bleach activator b) is present in an amount between 5 and 95 wt-%, and wherein cellulose ether c) is present in an amount between 1 and 50 wt-%, and wherein polysaccharide absorbent d) is present in an amount between 1 and 50 wt-%.

10. The granule according to any of claims 1 to 9, wherein this contains at least one of the additional ingredients selected from the group consisting of
e) an inorganic filler,
f) a siccative selected from the group consisting of alkali metal sulfate, alkali metal carbonate, alkaline earth metal sulfate, alkaline earth metal carbonate, alkaline earth metal oxide, aluminum oxide and/or hydrates of these compounds,
g) an enzyme,
h) a film forming polymer selected from the group consisting of polyvinylpyrrolidones, polyalkylene glycols, polyvinyl alcohols, polyacrylic acid homo- or copolymers, polymethacrylic acid homo- or copolymers or salts of these homo- or copolymers, or a combination thereof,
i) a water soluble non-polymeric organic builder and/or an inorganic builder differing from component e),
j) a water soluble polymeric co builder different from ingredient d),
k) water soluable dyes or water insoluble pigments, and
l) fatty acids, esters of fatty acids, esters of carboxylic acids with fatty alcohols or waxes,
wherein these ingredients are present in the following amounts
0-95 wt % of component e),
0-95 wt. % of component f),
0-20 wt. % of component g),
0-1.5 wt % of component h),
0-50 wt. % of component i),
0-1.5 wt. % of component j),
0-5 wt. % of component k), and
0-5 wt. % of component l),
wherein the percentages refer to the total amount of the granule, provided that, if component j) is present component i) is also present and that the total amount of components h) and j) in a granule is between 0 and 1.5 wt %.

11. The granule according to claim 1, wherein the polysaccharide absorbent d) is a starch.

12. The granule according to claim 1 containing, 5-20 wt.-% of component a) and 95-50 wt.-% of component b).

13. The granule according to claim 1 consisting essentially of one or more of components a) and b), and of a) and c), and of a) and d) and of a), b), and c), and of a), b), and d) and of a) b), c) and d).

14. The granule according to claim 1 comprising no acidic components.

15. The granule according to claim 1 comprising 2-25 wt.-% of component a), 50-80 wt.-% of component b), 5-15 wt.-% of component c), and 10-30 wt.-% of component d).

16. The granule according to claim 1 containing component c) as an anti-agglomeration agent.

17. The granule according to claim 1 comprising at least one of set (i), 70-95 wt.-% of component a) and 2-30 wt.-% of component d) or set (ii) 70-95 wt.-% of component a) and 3-30 wt.-% of component c).

18. The a granule of claim 1 and further comprising at least one or more of a peroxy compound or a precursor of a peroxy compound to form a bleaching formulation.

19. The granule of claim 1 further comprising a nonionic and an anionic surfactant to form a detergent or cleaning agent.

20. The granule of claim 1 for use in a detergent or in a cleaning agent.

21. The bleaching catalyst as defined for component a) in claim 1 for use as a binder for granules.

22. An uncoated granule comprising
a) 1-95 wt-% of a precursor of a manganese bleaching catalyst, said precursor being a chelating ligand L or L-BG-L, or a mono- to hexa-protonated salt of a chelating ligand L or L-BG-L
wherein
L and L-BG-L independently represent a nitrogen donor ligand, in which L is a monocyclic triamine and BG is a divalent organic bridge group,
and
an anti-agglomeration agent selected from the group consisting of at least one or more of components b), c) and d), wherein
b) is a bleach activator which is present in an amount between 0 and 95 wt-%,
c) is a cellulose ether, which is present in an amount between 0 and 50 wt-%, and
d) is a polysaccharide absorbent selected from the group consisting of starch, modified starch, glycogen and natural gum, which is present in an amount between 0 and 50 wt-%,
which granule contains between 0 and 1.5 wt.-% of a water-soluble film-forming polymer selected from the group consisting of polyvinylpyrrolidones, polyalkylene glycols, polyvinyl alcohols, polyacrylic acid homo- or copolymers, polymethacrylic acid homo- or copolymers or salts of these homo- or copolymers.

23. The granule according to claim 22, wherein L is a ring of formula (I) or L-BG-L is two rings of formula (I) linked via an organic divalent group BG 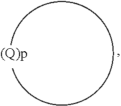
wherein:
Q is —NR—CR¹R²—CR³R⁴— or —NR—CR¹R²—CR³R⁴—CR⁵R⁶—
p is 3,
R is independently selected from the group consisting of hydrogen, C₁-C₂₄-alkyl, CH₂CH₂OH and CH₂COOH, or one R is linked as a divalent group BG to the nitrogen atom of another Q of another ring of formula (I), wherein BG is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups; and,
R₁, R₂, R₃, R₄, R₅ and R₆ are independently selected from H, C₁-C₄alkyl and C₁-C₄-alkylhydroxy.
